(19) United States
(12) Patent Application Publication
(10) Pub. No.: US 2007/0125013 A1
(43) Pub. Date: Jun. 7, 2007

(54) Finishing system for wall openings

(75) Inventor: Jack R. Prince, West Bountiful, UT (US)

Correspondence Address: HOLME ROBERTS & OWEN, LLP, 299 SOUTH MAIN, SUITE 1800, SALT LAKE CITY, UT, 84111, US

(73) Assignee: Cuatro, LLC

(21) Appl. No.: 11/272,856

(22) Filed: Nov. 14, 2005

(51) Int. Cl. E06B 1/04

(52) U.S. Cl. 52/204.1

(57) ABSTRACT

A wall has a framed opening primarily for a window. A window unit is installed in the framed opening. A decorative unit is formed or preassembled from moldings and jambs and is thereafter installed into the opening to finish the opening and provide structure to receive coverings like a blind or a shutter. The decorative unit has a recess formed along the interior of the moldings which is sized to receive window blinds, shutters or window shades. Springs or sealing members are positioned between the molding and the perimeter of the installed window or door unit to seal and spring load the jambs between the unit and the molding. Clips and brackets may be used to facilitate preassembly and installation. The molding may be in two pieces with a finish piece that snaps onto or over brackets to secure the molding without need for more permanent means to affix in place.

### BACKGROUND OF THE INVENTION

1. Field of the Invention

The present invention relates to systems, products and methods of forming or finishing an interior wall opening with finishing pieces and inserting them into a wall opening; and the present invention further relates to interior wall opening finishing systems using components that are precut for standard opening sizes for on-site assembly and installation; and even more particularly the present invention relates to interior window finishing systems using components that are configured to interface with or accept a window covering and that are precut for standard window sizes for on-site assembly.

2. Background Information

For many typical residential homes and for other buildings constructed using similar construction techniques, wall openings such as window openings and door openings are formed when framing a wall like an exterior wall during construction (new or remodel). To form a door opening or window opening, the framing members are typically cut and formed into the desired shape of the opening. The opening so formed can be called one of a variety of terms including the “roughed in door,” the “door frame,” the “rough window,” the “roughed-in window” and the “framed window” or “roughed framed window.” The window or door opening is typically constructed (sized) to receive a standard window assembly or door assembly with dimensional allowances to easily receive a desired window assembly or door assembly. Drywall or other suitable interior finishing material is then affixed to the framing members to form the wall surface on the interior. The exterior is similarly finished with suitable exterior material(s). Insulation may be placed in the space between the exterior surface and the interior surface.

To complete the formation of a window or door, a window or door unit, system or assembly is installed in the opening. Some window units and door units are identified as “pre-hung.” Pre-hung windows in effect are a combination of a window (with transparent or translucent panes being held by framing) with its related jambs, lintel member and depending on style, a sill.

To install a pre-hung window or door, it is inserted into the appropriate opening formed in the wall and secured in place. Shims and/or mounting fins are often used to square and secure the pre-hung window or door in the wall opening assuming that the wall opening has suffered dimensional changes or was constructed so that it was not dimensionally exact. If the wall opening is too small, the user can remove frame material by any suitable technique (e.g., saw, chisel, sanding). The pre-hung window is thereafter nailed, screwed, glued or otherwise fastened to the framing members that form the window opening. Window and door casing (sometimes called molding) is then cut to fit and nailed at the interior along the jambs and other portions to “finish” the window. Depending on the methods, the nail or screw holes are covered or filled with a filler, sanded, sealed and painted. The exterior may be similarly finished.

While the interior surface of the wall may be any suitable material, drywall is found regularly as the preferred material. The interior surface material covers the framing members and extends up to the inner edge of the framing members forming the window opening. Typically, that edge is not finished as it is covered by the jambs and casing or molding. In some cases, it may be desired to finish the edge using beading or even dry wall tape as known to those skilled in the art.

Even though window and door openings are typically cut to standard sizes, dimensions may vary because the framing members (e.g., wood) change dimensions. For example, changes in humidity can lead to changes in dimension. The foundation of the structure, being new, may shift a little again leading to dimensional variations. Changes can occur over time which is as short as the time between framing and finishing because the framing members could be assembled using wood that is still not fully “dry.” That is, the wood may contain sap and other liquid/moisture which has not yet evaporated. Of course dimensional changes may also be introduced by those who construct the frame and in turn the door and window openings.

In short, despite the fact that window and door units or assemblies including pre-hung windows and doors are typically manufactured in standardized sizes, the process of constructing window openings in the wall/framing typically results in the creation of window openings and door openings that vary from the desired exact standardized dimensions. For example, the thickness or depth of the opening can vary; and the opening may not be fully square. In turn, the casing or molding may not be easily installed. That is, steps must be taken to deal with the dimensional variations thus consuming, at the very least, additional labor in turn leading to additional cost in the construction of the window system and the building.

There is a need for systems that would simplify the finishing process to enable mass production of standardized interior window frames and standardized interior window coverings that do not need to be subsequently custom fit for each individual window opening.

### SUMMARY OF THE INVENTION

A wall opening is configured to receive a finishing unit such as a window or a door. The wall opening is formed from frame means that define the wall opening. Interior wall material like dry wall and an exterior wall material like exterior siding or plywood are secured to the frame means to create an interior wall surface and an exterior wall surface, respectively. The finishing unit has perimeter means to hold window material or retain door structure or material. The finishing unit may have a flange or other structure for securing the finishing unit to the exterior wall material or to the frame means with the perimeter in the window opening. The perimeter means is for positioning in and for orientation toward the frame means.

An assembly of the present invention is for quickly and easily finishing the wall opening on the interior side. That is, the wall opening when constructed may have many dimensional variations. The finishing unit may be out of plumb and the framing may be out of square. In turn, when, for example, the finishing unit is a window, the finished sill, jambs and casing all have to be cut to fit. In other words, the framing is dimensionally close to standard dimensions with variations being perhaps less than and one inch and more often less than one half inch. The dimensional variations are nonetheless sometimes too big to attempt to use calk or other fillers to deal with the gaps if one were to use standard size materials in an attempt to finish the window or door with precut standard sized jambs, sill, lintels and casing/molding. That is, roughed in windows and doors may present an opening that is fairly close to standard dimensions. The window openings are off or vary from the standard dimensions with sufficient frequency that it requires additional labor and material in comparison to a wall opening that is made to exact standard dimensions to finish the opening with jambs, sill, lintels, and casing (i.e., molding).

The assembly of the present invention is thus provided in standard sizes but made slightly less in dimension than the standard rough frame opening. For example, a window that is roughed in at 48 inches by 48 inches may in reality be 47 and ⅞ inches wide at the top and 48 and ⅛ inches wide at the bottom. At the same time, the finishing unit may be installed so that it is not perfectly vertical. In turn, an assembly that has corresponding dimensions of 47 inches by 47 inches will fit within the opening with tolerances, for example of about one half inch, that vary around the perimeter of the window opening. In turn, the assembly of the present invention is preassembled and may be aligned in the rough framed window opening to be oriented as desired. That is, it may be oriented to be in alignment with the components of the finishing unit or oriented to be substantially level and substantially vertical given the tolerances of a level used by carpenters or other finishing persons. Thus, the labor for finishing the window is substantially reduced because the need to dimensionally fit is eliminated. In addition, less material will be wasted in production/construction because of errors, or because of other dimensional considerations.

The assembly of the present invention may have spring means positioned between the jambs and the molding or between the jambs and the perimeter of the finishing unit to deal with vertical variations and to deal with other skewing of the finishing unit.

The assembly of the present invention has molding means formed and sized for positioning over the interior wall material. The molding means has an interior edge and an exterior edge. The interior edge is positioned in the wall opening. The width of the molding means is selected to position the exterior edge over the interior wall material a sufficient distance for securing the molding means over the interior wall material.

The assembly of the present invention includes jamb means for providing an interior finish surface between the perimeter means of the finishing unit and the molding means. The jamb means is sized in length to extend along the length of the interior edge of the molding means. Some form of spring means or other means is provided to urge the jamb means toward one of the molding means or the perimeter means. That is, the urging means is configured for positioning between one of the molding means and the jamb member or between the perimeter means and the jamb member.

In some arrangements the frame means is at least one framing member having a frame member length. The at least one framing member defines the wall opening. The finishing unit has at least one perimeter member oriented toward the at least one framing member.

In one configuration, the jamb means and the molding means are unitarily formed together. The urging means may also be something that has a spring characteristic and is or functions like a spring (i.e., spring means). The urging means is thus positioned between one of the jamb means and the perimeter member.

In some configurations, the urging means also functions as and may be said to include or be a seal member which simultaneously urges the jamb means toward one of the molding means or toward the perimeter means. At the same time, it effects a seal between the jamb and either the molding means or the perimeter means. In some applications there is an urging means which may include or be a seal member positioned between the jamb and the molding means and also between the perimeter means and the jamb.

It should be understood of course that many windows are rectangular in shape or projection. They may also be circular, ovular, square, octagonal, or in other geometric forms (in projection).

In some preferred applications, the framing means is a plurality of framing members. In other applications, there may be three or four framing members. Similarly, in some applications, there are a plurality of molding members which may be three or four. Also there may be a plurality of jambs including three or four.

In one preferred arrangement, two jamb members adjacent each other may be secured by jamb fastening means. Desirably, the jamb fastening means includes a rigid clip having a base with a first upstanding section for positioning proximate one of the two adjacent jambs and a second upstanding section for positioning proximate the other of the two adjacent jambs. The rigid clip also has first securing means for securing the first upstanding section to one of two adjacent jambs and a second securing means for securing the second upstanding section to the other of the two adjacent jambs. In a preferred configuration, the first upstanding section and the second upstanding section are unitarily formed with the first upstanding section and the second each being bent relative to the base.

In a more preferred arrangement, each the two adjacent jambs have ends for positioning proximate each other. The jamb fastening means includes a first groove transversely formed in one of the two adjacent jambs, a second groove transversely formed in the other of the two adjacent jambs and a clip having a first leg and a second leg joined together. Both the first leg and the second leg have one of two spaced apart fingers each of which is sized to engage one of the grooves. The first leg and the second leg are each sized in length to urge or pull the first jamb toward the second jamb.

In one embodiment, the molding means includes at least one molding member with its interior edge positioned within the window opening. The molding member includes window covering support structure extending away there from and configured to receive and support a window covering like shutters. The window covering support structure includes an “L” support to receive and support a window covering. The “L” support preferably has a first leg extending from the interior edge transversely toward the window to a first leg distal end. The “L” support includes a second leg extending transversely from the first leg distal end into the window opening.

In yet another embodiment, the window covering support structure includes a base for attachment to the interior edge of the molding member. A light shield member is extending there from to shield light at the edge of blinds or even a shade.

In an alternate configuration, the molding member includes at least one molding member having two opposite ends. A groove is formed in the inner surface of the molding member to extend between the two opposite ends. Each of the jambs is formed with a tongue sized to engage the groove. A spring means is preferably positioned in the groove to urge the jamb toward the perimeter.

In yet a further arrangement, the assembly includes a plurality of brackets for securing to the interior wall material proximate the window opening. Each of the plurality of brackets has a base with a distal end extending into the window opening and a leg extending from the distal end toward the window unit. The assembly further includes first fastening means for securing a molding member thereto and second fastening means for securing one jamb to a leg. Preferably the brackets are spaced apart about the window opening. Desirably, the base of each bracket has a proximal end with a first tip extending away there from and a second tip extending away from the distal end. Each molding member has an interior surface with a recess formed therein. The recess has a first side extending into the molding member. The first side has a first ridge formed there along positioned and sized to engage the first tip. Similarly, the recess has a second side extending into the molding member. The second side has a second ridge formed there along sized and positioned to engage the second tip.

In one alternate configuration, the jamb members have an outer face oriented outwardly from the window opening. The outer face has a jamb groove formed therein; and the molding member has a tongue sized and positioned to engage the jamb groove.

In yet another alternate configuration, each of the plurality of brackets has a first engaging member extending away from the base of the bracket and spaced inward from the distal end of the base. The interior surface of each of the molding members has a first groove formed therein sized to engage with a first engaging member to hold the molding member to the bracket.

In a further configuration, each of a plurality of brackets has a second engaging member extending away from the bracket. The interior surface of a molding member has a second groove formed therein which groove is sized to engage the second engaging member to hold the molding member to the bracket. The first groove and second groove may be sized to permit removal of the molding member.

In yet other arrangements, second fastening means includes an engaging member extending from the first leg and a slot formed in each jamb sized to receive the engaging member and to hold the jamb to the engaging member. Preferably the engaging member is “T” shaped in cross section with a stem and a cross member having a width, a height and a depth. The slot includes a throat sized in width to receive the stem and to receive the width of the cross member. The slot includes a cross member recess formed in the jambs to receive the cross member.

In alternate configurations, the perimeter members have an accessory recess formed therein oriented inwardly toward the jambs. Each of the jambs has an accessory tongue formed for positioning in the accessory recess. In one arrangement, the accessory recess has an engaging shoulder; and the accessory tongue is formed with a lip sized to engage the engaging shoulder.

In configurations in which each perimeter member has an accessory recess formed therein oriented inwardly toward the jambs, the assembly further includes a plurality of clips each sized for positioning in a accessory recess. The clips are configured to engage the jambs. Preferably each of the jambs has a perimeter face for orientation toward the perimeter members. Each of the jambs has a slot formed to extend inwardly from the perimeter face. A plurality of alternate clips is formed to have a first outwardly extending leg and a second outwardly extending leg. The second outwardly extending leg has a distal end with a spring member extending there from. The jamb members have an inner surface with the slot being sized to receive the first outwardly extending leg. The second outwardly extending leg is configured to extend along proximate the inner surface of the jamb with the spring member being urged against the inner surface.

In alternate assemblies, a plurality of clips are formed with a first engaging section sized to be movable between a first position in which it engages the accessory recess and a second position in which the first engaging section is reduced in size to disengage from the accessory recess. The plurality of clips each have a first leg and a second leg spaced apart from the first leg to extend from the first engaging section. The first leg and second leg also have a second engaging section that can be moved by a user between a first position in which the second engaging section engages the slot in the jambs and a second position in which the second engaging section is disengaged from the slot. Alternately, the jambs may be formed with a tongue sized to engage the accessory slot formed in the perimeter members.

In configurations where the molding means and the jamb means are formed as one piece or otherwise assembled to define and form an exterior ledge along their lengths, a window covering adapter may be used. The adapter has a lip sized to engage the exterior ledge; and it has a base for attachment to and to abut the jamb. The adapter has an extension to extend away from the base. In one version, the extension is positioned to receive window shutters. In other configurations, the extension acts as a light block for window blinds and window shades.

In selected configurations, the molding members have a base with an interior surface for positioning on the wall or wall material. The molding members also have an exterior surface oriented away from the wall material. The exterior surface of the molding members have a recess with a preselected depth running the length of the molding member. The recess has a first side and a second side. The first side has a small ridge extending into or toward the interior of the recess. The ridge has a ridge surface oriented at a first angle relative to the first side. The second side of the recess has a height with an indentation formed therein proximate the exterior surface of the base. The molding member has an insert sized for snug positioning in the recess. The insert has a first side for positioning proximate the first side of the recess. The first side of the insert has an upper ridge with an angular surface positioned to abut or to interface with the ridge surface of first side of the base. The insert also has a second side with a ridge proximate its outer surface sized to fit into and snap into the indentation in the second side of the recess. The insert has an insert recess oriented toward the recess of the base to form a cavity sized to retain securing means (e.g., heads of screws) for securing the molding member to the wall.

In many configurations, the opening will be rectangular in projection with the finishing unit being a window. Of course, today, wall openings for windows can also come in a wide variety of shapes including circular, ovular, rectangular, triangular, octagonal and whatever other polygonal shape may be of interest to the user.

Methods for framing an opening in the wall of a building include the steps of: providing a wall with an opening formed therein sized to receive a decorative or finishing unit. A decorative frame unit is formed to install proximate an installed finishing unit. The decorative frame unit has a molding frame made from molding members extending about and proximate the perimeter of the wall opening. The jamb frame is made of jambs having an inner edge and an outer edge. The jamb frame is sized to extend from the finishing unit to the molding frame. and is secured by and between the molding frame and the finishing unit. The decorative frame unit is thereafter positioned, squared and secured in the wall opening. In more preferred methods, a spring means is positioned between the molding frame and the jamb frame.

### BRIEF DESCRIPTION OF THE DRAWINGS

In the drawings, which illustrate what are presently regarded as preferred embodiments of the invention:

FIG. 1 is a perspective exploded and partial cut-away view of an opening in a wall along with a finishing unit and a decorative frame unit or interior framing system in accordance with the present invention;

FIG. 2 is an enlarged portion in perspective of part of the exploded view of the opening in a wall along with the interior window framing system of FIG. 1;

FIG. 3 is a side planar view of an octagonal window opening;

FIG. 4 is a side planar view of an ovular window opening;

FIG. 5 is a side planar view of a circular window opening;

FIG. 6 is a perspective of a finishing unit of FIG. 1;

FIG. 7 is a planar view of the finishing unit of FIG. 1;

FIG. 8 is a perspective partial view of a jamb member and a molding member assembled for positioning in a window opening;

FIG. 9 is a partial perspective view of a jamb member of FIG. 8, with additional urging and sealing means;

FIG. 10 is a front planar view of a window framing system of the present invention;

FIG. 11 is a front planar view of a jamb frame of a window framing system of FIG. 10;

FIG. 12 is a cross section of the window framing system of FIG. 10 at section lines 13-13;

FIG. 13 is a perspective view of an “L” bracket for use with the framing system of FIG. 10;

FIG. 14 is a top planar view of a corner bracket for use with the framing system of FIG. 10;

FIG. 15 is a perspective view of a corner bracket of FIG. 14 in use;

FIG. 16 is top view of an alternate corner arrangement for use in a jamb frame of FIG. 11;

FIG. 17 is a top view of an alternate corner arrangement for use in a jamb frame of FIG. 11;

FIG. 18 is a partial planar view of the partial alternate jamb frame of FIG. 19 looking from the finishing unit toward and framing system;

FIG. 19 is an exploded perspective view of a partial alternate jamb frame for use with the window framing system of FIG. 10;

FIG. 20 is a partial exploded cross sectional view of an alternate bracket for use with a framing system of claim 10;

FIG. 21 is an exploded cross sectional view of an alternate configuration for a framing system;

FIG. 22 is an alternate cross sectional view of a jamb member for use with the framing system of FIG. 21;

FIG. 23 is an alternate cross sectional view of a framing system;

FIG. 24 is a partial top planar view of an alternate configuration of a framing system of FIG. 10;

FIG. 25 is a partial cross sectional view of an alternate configuration of a framing system of FIG. 10;

FIG. 26 is a partial cross section of a connector for use with the alternate configuration shown in FIG. 25;

FIG. 27 is a partial cross section of a connector for use with the alternate configuration shown in FIG. 25;

FIG. 29 is a partial cross sectional view of an alternate assembly for finishing a wall opening;

FIG. 29 is a partial exploded perspective of the alternate assembly of FIG. 28;

FIG. 30 is a partial cross sectional view of another alternate assembly for finishing a wall opening;

FIG. 31 is a partial cross sectional view of an alternate arrangement of the accessory channel of a perimeter member and a jamb member;

FIG. 32 is a partial cross sectional view of another alternate arrangement of the accessory channel of a perimeter member and a jamb member;

FIG. 33 is a partial cross sectional view of an alternate arrangement of the accessory channel of a perimeter member and a jamb member with a clip in the accessory channel;

FIG. 34 is a partial cross sectional view of a clip for use in the accessory channel;

FIG. 35 is a partial cross sectional view of an alternate clip, accessory channel and jamb member;

FIG. 36 is a cross sectional view of an alternate molding member for use in or with an assembly for finishing a wall opening;

FIG. 37 is an alternate cross sectional view of a molding member and jamb member unitarily assembled; and

FIGS. 38 and 39 are partial cross sectional views of the molding member and jamb member of FIG. 37 with an attachment for a window covering.

### DETAILED DESCRIPTION OF THE EMBODIMENTS

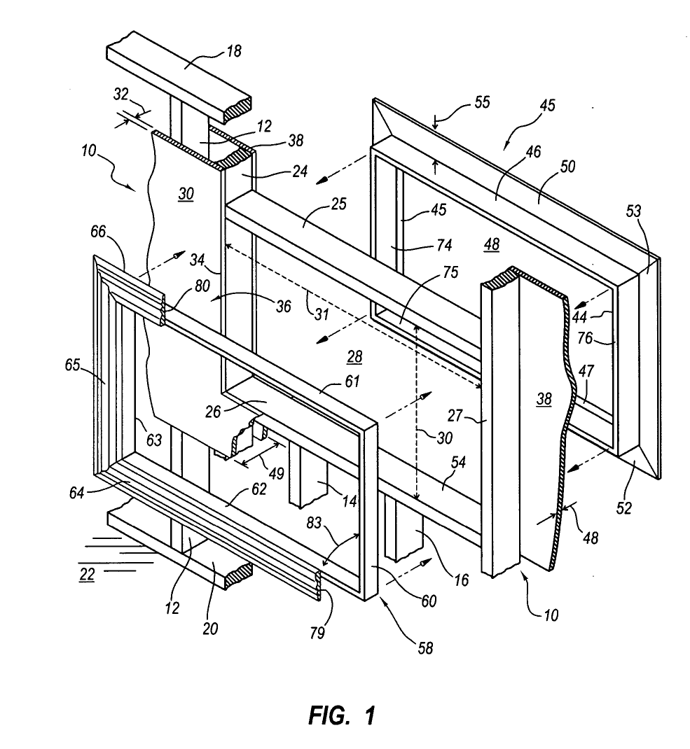

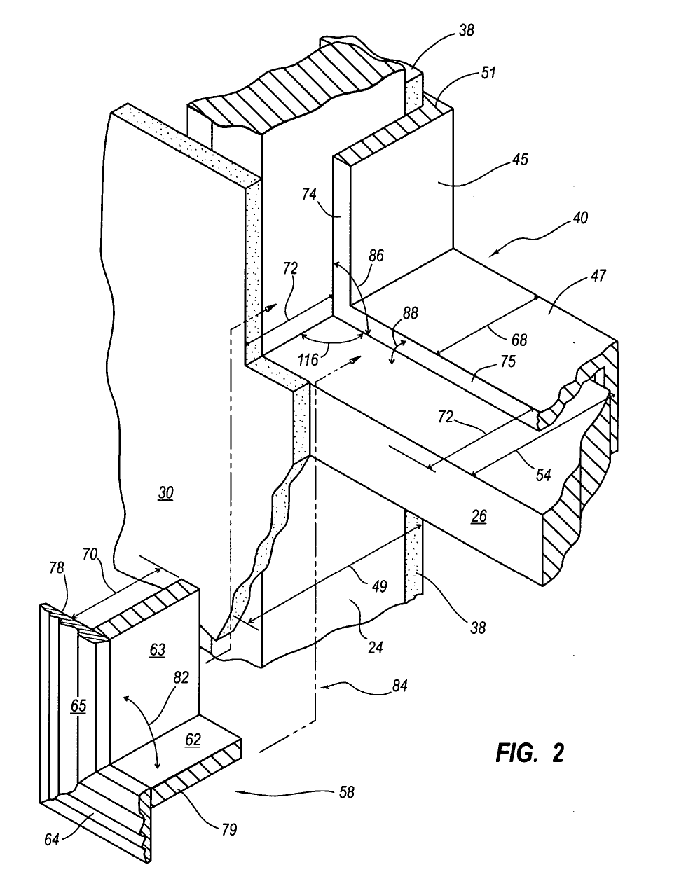

FIGS. 1 and 2 are exploded cut-away views showing a wall 10 of a home or other building constructed in a similar fashion. The wall 10 is constructed from framing means for forming the wall 10. The framing means is here depicted to include a plurality of framing members which include framing members 12, 14 and 16 as examples. Some times framing members are referred to as studs. Framing member 12 is an example of a stud that extends from a wall header frame member 18 to a footer frame member 20 which is itself positioned on and typically secured to a floor 22. While framing members like framing member 12 are typically made of wood, some buildings employ metal framing members. The framing means may also include frame members 24, 25, 26 and 27 assembled to form and define an opening 28 in the wall 10 sized to receive a finishing unit. Some openings may be formed in a way to receive a prehung door (typically three sided) while others are formed to receive a window assembly as discussed hereinafter.

The wall 10 is formed from and includes an interior finishing material 30. While any suitable interior material may be used, it is typically ½ inch thick 32 dry wall or sheet rock that is cut with an edge 34 that extends up to and over the frame members like frame member 24 to form the perimeter 36 as shown. The interior finishing material is not shown over frame members 14, 16, 25, 26 and 27 to facilitate illustration. The interior finishing material 30 is typically secured to the framing members like frame members 12, 14, 16 and 24-27 by fasteners that include suitable nails, staples or screws (not shown). Glues may also be used. Indeed, any suitable fastener or fastening means can be used so long as it effects a mechanical connection of the interior finishing material 30 to the frame means. The interior finishing material 30 may also include paneling or any other wall material selected by the user including tiles, stones, logs, woods, plywood and the like.

The wall 10 also includes an exterior material 38 that may be any suitable material or approved material for use on the exterior of a structure. The exterior material 38 could be drywall intended for use in the interior of a house or other building if the wall 10 was in the internal portion of a building. In FIG. 1, the wall 10 is an exterior wall having the exterior material 38 oriented toward the exterior of the building. The exterior material 38 may be plywood, pressed wood, industrial board, or other synthetic or composite material over which one typically affixes yet further finishing material(s) including tar paper, brick, stone, siding, stucco or the like. The exterior material 38 is secured to the frame means by any suitable means such as nails, screws, fasteners, glues or any other material in which a mechanical connection between the exterior material 38 and the frame means such as the frame members 12, 14, 16, 18, 20 and 24-27, is effected.

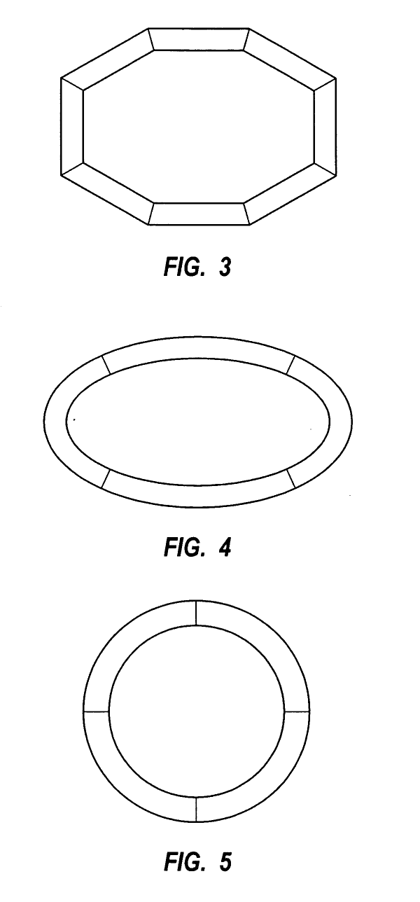

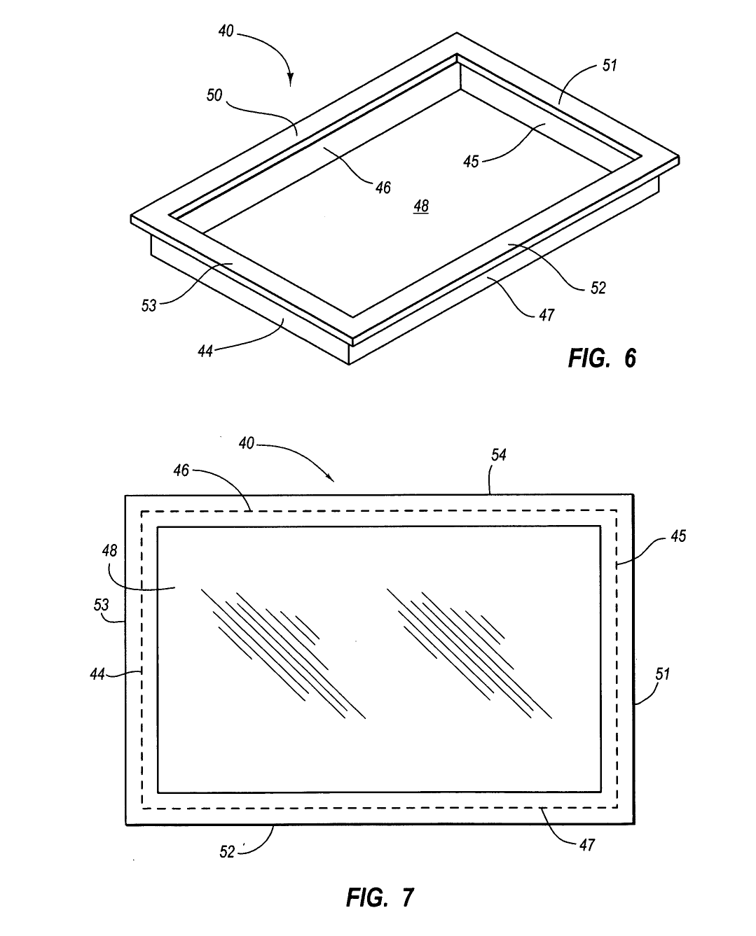

The finishing unit of FIG. 1 is here intended to be any suitable product that is pre-made or assembled for insertion or placement into and secured in a wall opening like opening 28. For example, the opening 28 could be three sided and in turn suitable for a door which could include prehung doors. By prehung, applicant is referring to a door which is assembled with a jamb and related moldings, a sill, hinges and the like to that it is complete but for installation and the application of finish molding or casing about. The opening 28 may also be for a window and in turn an opening sized to receive the finishing unit 40 therein. While the opening 28 here shown in FIG. 1 is rectangular in projection or shape, it may also be in any shape desired by a user including octagonal (in projection) as seen in FIG. 3, ovular as seen in FIG. 4 and circular as seen in FIG. 5. Various other ovular and polygonal shapes may be used as well as configurations that include combinations of arcuate portions and rectalinear portions. That is, the window opening may be formed in any shape desired by the user.

The finishing unit 40 shown is a window assembly that has been preassembled at a factory or on site. It has perimeter means which is here shown to be a plurality of four perimeter members 44, 45, 46 and 47. Of course the number of perimeter members will change based on the shape or configuration of the window opening 28.

The finishing unit 40 typically has windows or other suitable structure (e.g., mirrors, leaded glass, translucent opaque synthetic material as desired by the user and secured within the perimeter means in a suitable fashion. The perimeter means is typically provided in a size to fit into the window opening 28 as more fully discussed hereinafter. The illustrated finishing unit 40 also has flanges 50-53 about the perimeter to extend away there from for placement over the exterior material 38. Suitable fasteners including nails, screws and glue may be used to fixedly secure the finishing unit 40 in the window opening 28.

It may be noted that the window opening 28 has a depth 49 that includes the width 54 of the framing members, such as framing member 26, plus the thickness 32 of the drywall and the thickness 48 of the exterior material 38. The thickness 56 of the finishing unit 40 is less than the depth 49 of the opening.

In FIG. 1, the finishing unit 40 is shown spaced away from the wall 10 and the window opening 28 for purposes of illustration. Similarly a finishing assembly or decorative frame unit 58 is also shown spaced away from the window opening 28 for purposes of illustration. The finishing assembly 58 includes a jamb means which is here shown to include a plurality of four jambs or jamb members 60, 61, 62 and 63 assembled into a rectangle (in projection) as more fully discussed hereinafter. Molding means is also illustrated in part to include a plurality of molding members such as molding members 64, 65 and 66. A fourth molding member is not shown and would extend along jamb member 60. The fourth molding member is not shown to simplify FIG. 1. The molding members 64-66 are secured to the wall 10 typically with the use of suitable nails or brads. Typically, the molding members have a sufficient portion over the frame members 24-27 so that nails may pass through the interior finishing material 30 directly into the frame members 24-27 to effect a secure attachment.

In FIG. 2, the finishing unit 40 is positioned and secured in the window opening 28. The perimeter members 45 and 47 have a depth 68 substantially less than the width 49 of the opening. The jambs or jamb members 60-63 are all sized in width 70 to be about the same as the jamb distance 72 between the interior faces 74, 75, 76 and 77 of the perimeter members 44-47 and the inside surfaces 78, 79 and 80 of the molding members 65, 64 and 66. Additional means are provided to allow for dimensional variations as hereinafter discussed.

In FIG. 2, it can be seen that the decorative frame unit or finishing assembly 58 is preassembled to be in plumb or square with angles 82 and 83 being 90 degrees plus or minus reasonable manufacturing tolerances. Thus upon insertion 84, the finished window will look in plumb or alignment even though the window opening 28 is not in plumb. For example, angles like angles 86 and 88 may not be 90 degrees but at least more than 1 or 2 degrees off from 90 degrees and in some cases more than 5 degrees off alignment.

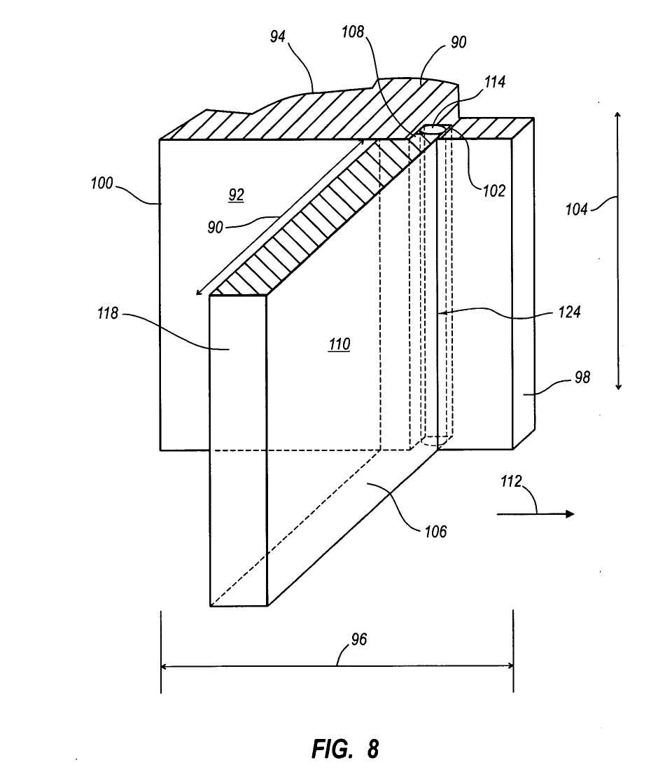

Referring now to FIG. 8, a molding member 90 comparable to molding members 64-67 is shown with an interior surface 92 and an exterior surface 94. The molding member 90 has a width 96 selected so that the inner edge 98 is positioned into the window opening 28 (FIG. 1) and the outer edge 100 is positioned away from the perimeter 36 of the window opening 28 and in turn away from the edge 34 of the drywall or interior finishing material 30. In turn there is sufficient material of the molding member 90 to receive nails or screws for fastening the molding member 90 to the wall 10 and more particularly to framing members like framing members 24 and 26. A groove 102 is formed in the interior surface 92 to extend along the length 104 of the molding member 90. The jamb 106 has a tongue 108 formed along its length 104 and sized to insert into the groove 102 thereby orienting a finish or exterior surface 110 of the jamb toward 112 the window opening.

In FIG. 8, an urging means for urging the jamb 106 toward the faces 74-77 of the perimeter members 44-47 is placed in the groove 102. The urging means may be any material that has sufficient resilience or sufficient spring characteristics to urge the jamb member 106 toward its respective perimeter member (one of 44-47). The urging means may be a spring material 114 or anything else that functions to urge the jamb member 106 to move relative to the molding member 90. Preferably, the urging means also functions to effect a seal. That is, the urging means may perform two functions, that of a spring and that of a seal. Various felt materials, rubbers, polymers and the like all have suitable resilience to function as a spring and at the same time provide effect a seal while urging the jamb 106 to move against the perimeters 44-47. While one urging means may be used, in some applications there is an urging means between the molding members and the jamb members which can be called the molding urging means that is in effect the molding resilient means. As seen in FIG. 8 as discussed herein after, another urging means may be used and placed between the perimeter members and the jamb members and thus can be called the perimeter urging means or perimeter resilient means.

While the jamb 106 has a standard size or width 70, it should be understood that the dimensions like the jamb distance 72 around the perimeter 36 of the opening may vary particularly if the angles like angles 86, 88 and 116 all vary or are not 90 degrees. With a jamb face 118 oriented toward a perimeter 44-47, the dimensional variations will cause the tongue 108 to compress the spring material 114 more in some spots or sections than in others along the length 104 of the molding member 90. In turn the jamb members 106 present a finished face 110 that in effect automatically adjusts to the opening.

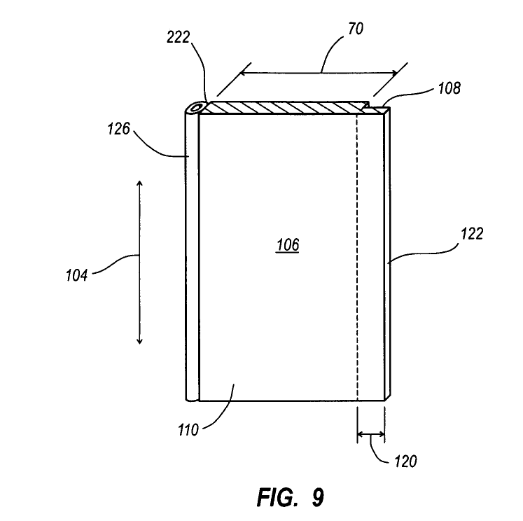

FIG. 9 is a partial perspective view of the jamb or jamb member 106 of FIG. 8. The tongue 108 has a width 120 which is selected to insert into the groove 102 a sufficient distance to provide for a finished surface even though the jamb distance 72 varies along the length 104 of the jamb 106. That is, the jamb distance at one end could be 2 inches at one end and 2.25 inches at the other. The width 120 of the tongue 108 and the depth of the groove 102 along with the thickness of the spring material 114 is such that the inner face 122 of the tongue will always be in the groove 102 thus providing a finished edge or corner 124 along the length of the jamb 106 and molding member 90.

In FIG. 9, a second or alternate urging means is shown to urge the jamb member 106 into the groove 102. The second urging means may be used solely or together with the urging means that is placed in the groove 102. The second urging means functions to urge the jamb as stated and also to effect a seal between the perimeter members 44-47 and the jamb face 118. The urging means shown is a spring member 126 sized to extend the length 104 of the jamb member 106. The spring member 126 is formed from a material that has sufficient resilience to perform the spring function and is yet pliable or flexible to perform a seal function to effect a weather seal and a seal to inhibit the movement of bugs, dirt and the like around the jamb member 106. The second spring member may be formed from material similar to that selected for the first spring member 114. It may be made so that it has or may be later colored to match the color of the surface 110 of the jamb member 106. As shown, the spring member 126 is somewhat compressed and is somewhat rectalinear in cross section. It can be seen that variations of the jamb distance 72 will lead to variations of the compression of the spring member 126 to effect a clean corner between the jamb member 126 and the perimeter members 44-47 and also between the jamb member 106 and molding member 90.

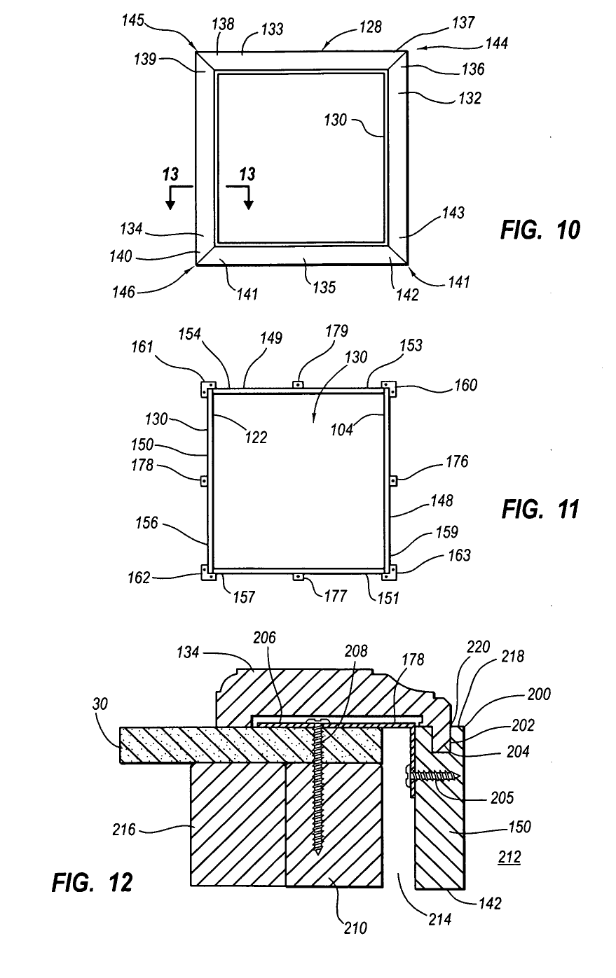

An assembly for finishing the window or other opening or window framing system is also a decorative frame unit or frame assembly 128 is shown in FIG. 10 with its related jamb assembly 130 shown in FIG. 11 and a cross section shown in FIG. 12. The assembly 128 has a molding means for proving a molding finish for a window opening. The molding means is here comprised of four molding members 132-135 assembled with the ends thereof 136-143 joined at 45 degree angles to form the four corners 144-147. Associated with the frame assembly 128 is the jamb assembly 130 having jamb means here shown to be four jambs or jamb members 148-151 assembled in an end-to-end relationship 152-159 as shown in FIG. 11. The ends 152-159 are held together using corner brackets 160-163.

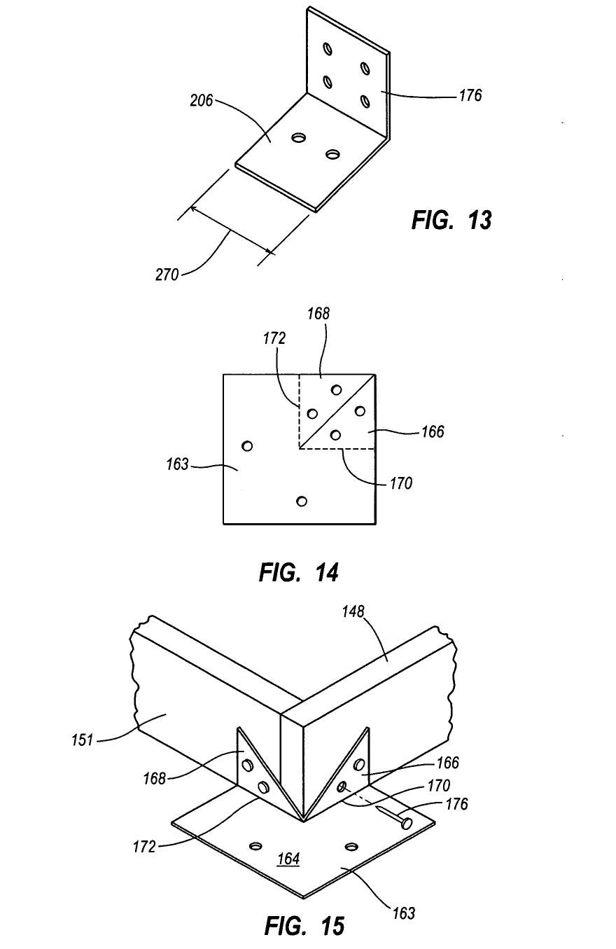

FIGS. 14 and 15 are enlarged illustrations of one corner bracket 163 having a base 164 with a first leg 166 and a second leg 168. The legs 166 and 168 are formed by bending them until they are approximately normal to the base 164 along fold lines 170 and 172. The legs 168 and 170 are of course separated in the stamping process or by other suitable means. While the brackets 160-163 are shown to be here formed from a metal that is stamped and bent to a desired shape, it should be clear that the brackets 160-163 could be made of a suitable plastic or the like using appropriate processes for forming plastic or plastic-like parts that have suitable or desired rigidity. The corner brackets 160-163 are provided with suitable holes to accommodate screws 176 or other suitable fasteners to affix the brackets 160-163 to the jambs 148-151.

To provide for additional stability for the jamb frame 130, the jamb members 148-151 may have additional “L” brackets 176-179 positioned along their lengths between their ends 152-159. FIG. 13 depicts in perspective one such “L” bracket 176. It is also provided with suitable holes or apertures to accommodate screws or other suitable fasteners.

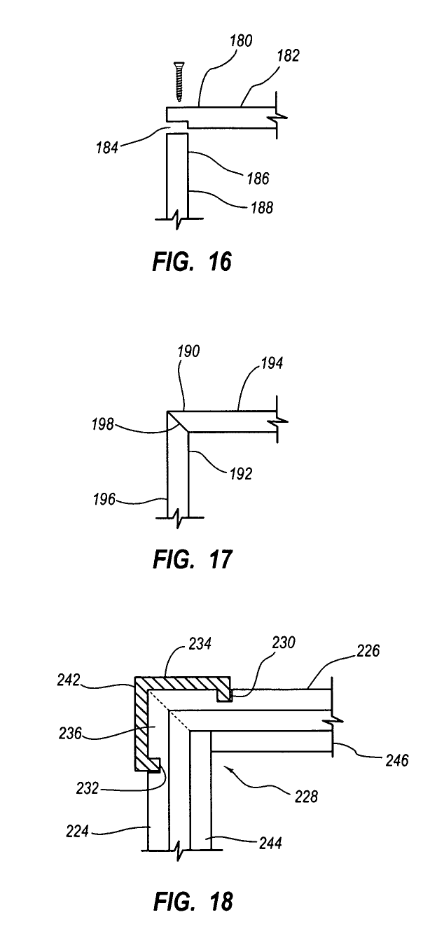

The corners 144-147 of the jamb members 148-151 are shown in FIG. 11 to be formed from the ends 152-159 in an end to end relationship. FIG. 16 shows and alternate arrangement where the end 180 of jamb member 182 is formed with a notch 184 to snuggly fit to the end 186 of an adjoining jamb member 188. FIG. 17 shows ends 190 and 192 of jambs 194 and 196 cut to have 45 degree faces to form a 45 degree joint 198 that may be held together using glue, brads, staples, screws, nails or the like.

Returning to FIG. 12, as stated, it is a cross section of the frame assembly of FIG. 10. The jamb member 150 is here shown formed with a molding face 200 having a groove 202 formed along its length and sized to receive a finger 204 of the molding member 134 sized to fit snuggly in the groove 202. The “L” bracket 178 is shown with a screw 205 holding it to the jamb member 150. The base 206 of the “L” bracket 178 is shown positioned over the interior wall material 30 and held securely thereto by a screw 208 that extends into a frame member 210 of the window opening 212 like frame member 27 (FIG. 1). In FIG. 12, it can be seen that the jamb member 150 is positioned with a gap 214 between the frame member 210 and the jamb member 150. The gap 214 is here shown to be enlarged for illustration because it may extend typically from zero inches to about as much as ½ inch with expected normal gap distances to range from about 1/16^{th} of an inch to about ⅜ of inch to accommodate dimensional variances in the formation of the window opening 28 and 212 using framing members as well as variations induced in the installation of a finishing unit like finishing unit 40. The gap 214 may in some cases be above ½ of an inch and can approach the width 55 of the flanges 50-53. In FIG. 12, the molding member 134 may be affixed to the interior finishing material 30 by suitable glues or by a suitable nails, screw or other fasteners extending into the finishing material 30 and preferably into the framing member 210 and possibly a related strengthening frame 216. The manner or means to effect the affixation of the molding members includes any suitable means desired by the user that leads to the desired mechanical holding or retention of the molding members preferably with an external finished appearance.

In FIG. 12, it can be seen the inner portion 218 of jamb face 200 is exposed and forms a finishing joint 220 with the molding member 134 that can vary as the jamb member 150 varies in its width like width 70 along its length 104 (FIG. 9) to accommodate for dimensional variations of the window opening like opening 28 (FIG. 1) and the placement of the finishing unit like finishing unit 40. Urging means, like spring 126 (FIG. 9) may be placed between the perimeter face 222 and the perimeter members 44-47 of the finishing unit like finishing unit 40 (FIG. 1) to urge the jamb member 150 toward the molding member 134 and to effect a seal.

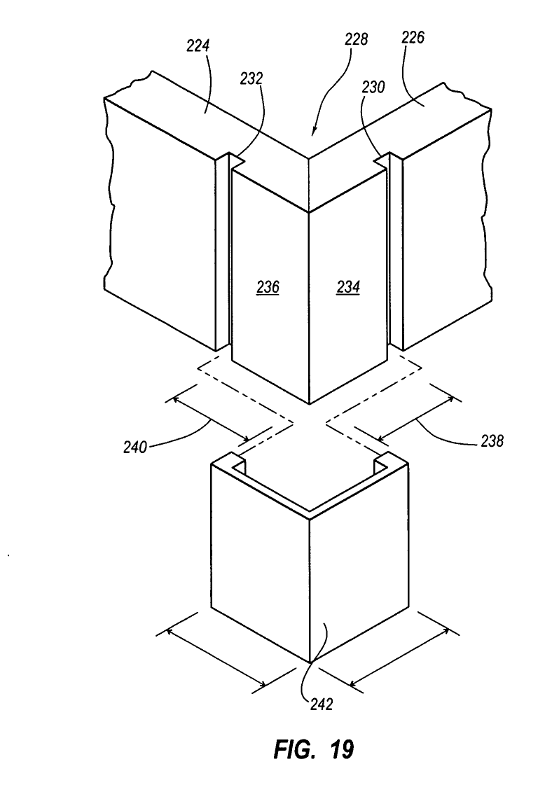

In FIG. 19, a jamb member 224 and jamb member 226 abut each other at a corner 228. Grooves 230 and 232 are formed in the jamb members 224 and 226 spaced in from the ends 234 and 236 a distance 238 and a distance 240 that are preferably equal. A locking clip 242 is here formed from metal with fingers 244 and 246 positioned to engage the grooves 230 and 232 when the locking clip 242 is inserted to hold the jamb members 224 and 226 together. As shown in FIG. 18, the clip 242 is positioned to secure the ends 234 and 236 to form a jamb frame comparable to that of FIG. 12 without the illustrated brackets for association with the molding members 244 and 246.

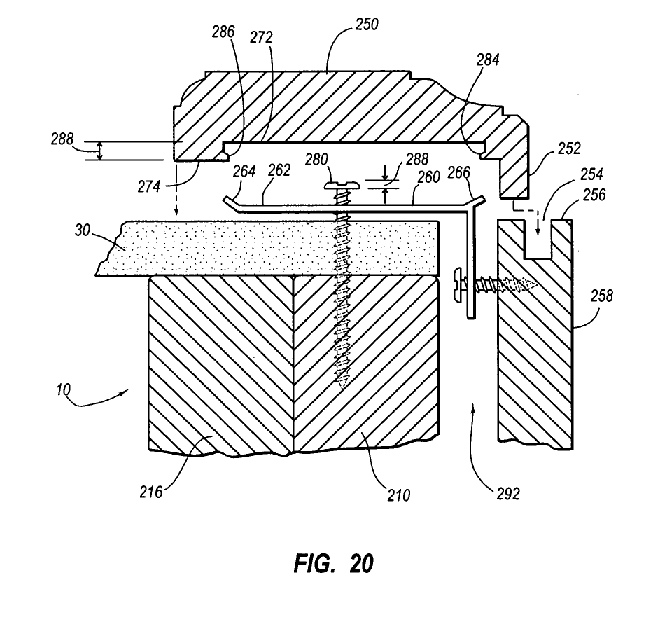

FIG. 20 is a cross section comparable to that of FIG. 12 but exploded with a molding member 250 having a finger 252 for inserting into the groove 254 formed in the face 256 of the jamb member 258. The “L” bracket 260 shown may be affixed to the molding member 258 by a suitable screw or other fastening arrangement to hold the jamb member 258 in place. The bracket 260 has a base 262 formed with a small finger 264 at its outer end and a small finger 266 at the crease 268 to extend the width 270 (FIG. 13) of the bracket 260.

The molding member 250 has a recess 272 formed in its inner surface 274. The first side 276 of the recess and the second side 278 of the recess 272 are each formed with a small ridge 284 and 286. The recess 272 is sized in depth 288 to receive the bracket 262 and the head 280 of the screw 282 which has a height 290 less than the depth 288 when installed. The base 262 of the bracket 260 is sized so that the fingers 264 and 266 effect a snap together connection with the ridges 286 and 284 thus securing the molding member 250 securely to the wall 10 and the interior finishing material 30 without the need for other fastening means. In turn, the user has a finishing system or assembly that can be easily removed so that it may be painted at a remote location, to allow the user to easily add additional insulation, control bugs, inspect for water or other damage from bugs or insects. The molding members like molding member 250 can be snapped off exposing the underlying exterior finishing material and allowing access to the gap 292. Of course the jamb members that form the jamb frame may also be removed by removing screws like screw 282. In turn the jamb members like member 258 can be easily cleaned or painted. Additional or replacement spring members like spring member 126 (FIG. 9) may also be added.

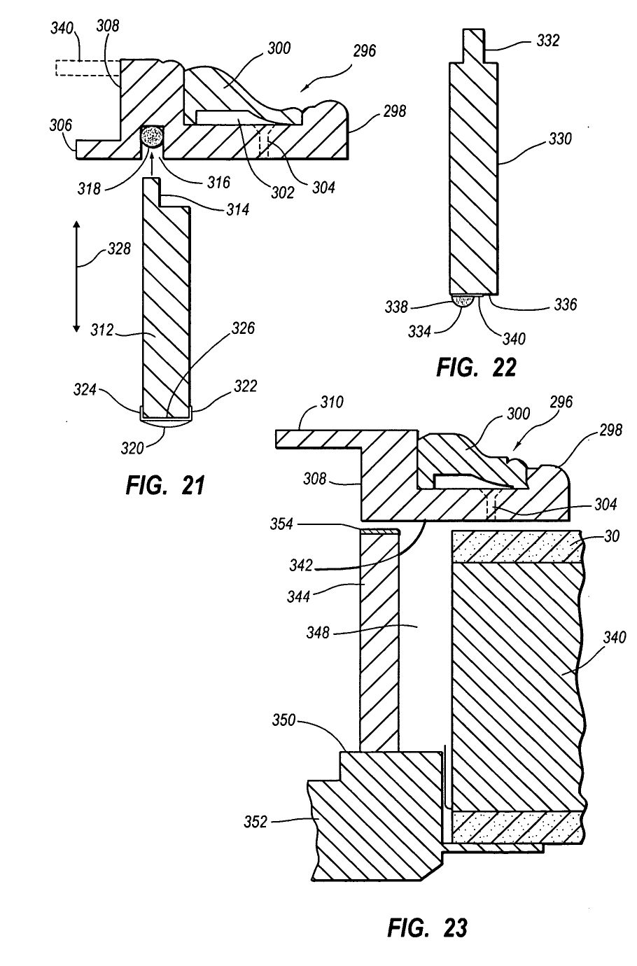

Referring now to FIG. 21, a molding member 296 has a base portion 298 with an insert portion 300. The base 298 is formed with a recess 302 sized to snuggly receive the insert portion 200. With the insert portion 300 removed, the user has access to the recess and may employ screws 304 to secure the molding member 296 to the interior finishing material and the underlying framing members. The molding member 296 is formed with a first ledge 306 and with a face 308 sized to receive a window covering like a window shutter. The hinges of the shutter may be mounted to the face 308 to effect a quick and easy mounting of an accompanying window shutter. An alternate or second ledge 310 is shown which is positioned to act as a light block when other window coverings are used including window shades and window blinds. That is, the ledge 310 blocks the light that can escape around the outer ends of the blind or shade.

In FIG. 21, the jamb member 312 has a finger 314 for insertion into the groove 316 with urging means and more particularly the spring member 318 in the groove 316 to urge the jamb member 312 toward the perimeter members of a finishing unit like finishing unit 40 of FIG. 1. A second urging means is shown here to be an end cap 320 that has a first flange 322 and a second flange 324 placed over the perimeter face 326 of the jamb member 312. The end cap 320 is resilient and in turn urges the jamb member 312 toward the molding member 296. The jamb member 312 is thus snuggly held in position but can float in dimension 328 as hereinbefore discussed.

An alternate jamb member 330 is shown in FIG. 22 with a finger 332 centrally positioned and with a spring and sealing member 334 affixed to the inner end or face 336. The sealing member may be any type of spring-like material including a polyolefin member 338 with a foot or base 340 to facilitate adhesion to the face 336.

FIG. 23 shows a molding member 296 as described in connection with FIG. 21 but with no groove in the underside 342 and configured with a face 308 and a light block 310. The jamb member 344 is shown spaced from the framing member 346 to form gap 348. The jamb member 344 extends from a perimeter member 350 of a finishing unit 352 with urging means in the form of a resilient spring member 354 positioned between the underside 342 and the jamb member 344 to urge the jamb member toward the perimeter member 350. The jamb member 344 has no fingers or grooves to effect a positive mechanical connection between the molding member 296 and the jamb member 344. The jam member 344 is held in place by the force exerted by the molding member 296 as it is secured to the wall 10 and more specifically the internal finishing material 30.

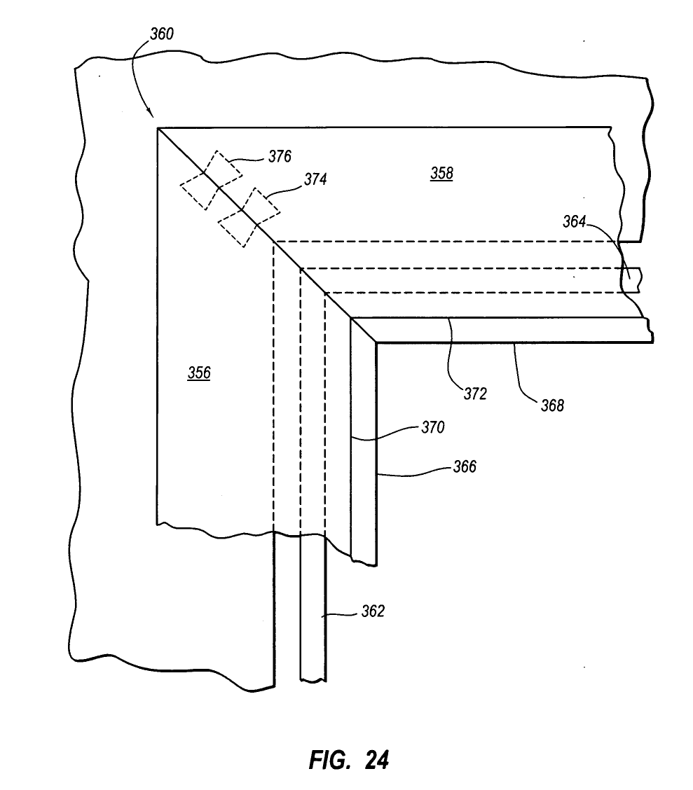

In FIG. 24, molding members 356 and 358 are joined together at a corner 360. Jamb members 362 and 364 are joined at the corners as hereinbefore discussed in connection with FIGS. 12, 15, 19 and 20. The molding members 356 and 358 have an appropriate ledge 366 and 368 comparable to ledge 306 with a corresponding face 370 and 372 comparable to face 308 (FIG. 21) configured to receive a window shutter. The molding members 356 and 358 are joined and held together with fasteners 374 and 376 that are sometimes called butter-fly fasteners or Hoffman joint fastener adhered to the back surface of the molding members 356 and 358 and in turn are here shown in phantom. The abutting relationship of the ends of the molding members 356 and 358 is thereby easier to maintain and help retain the molding members in a dimensionally stable assembly.

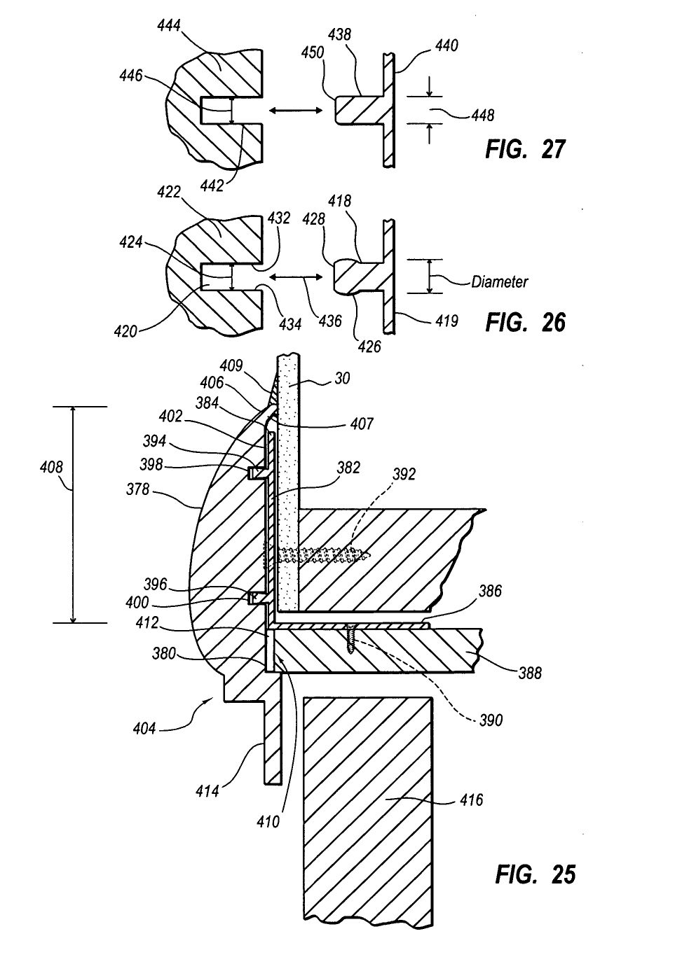

An alternate bracket arrangement is shown in FIG. 25. The molding member 378 has a notch 380. The bracket 382 has a base 384 and a leg 386. The leg 386 is secured to the jamb member 388 using a suitable fastening arrangement which is here depicted by a screw 390. The bracket 382 is itself fastened much like those hereinbefore with the base 384 being held to the interior finish material 30 by a suitable screw 392 or other appropriate fastener. The base 384 has at least one and preferably two outwardly extending members or pegs 394 and 396. The pegs 394 and 396 are each sized to frictionally engage grooves 398 and 400 formed in the interior surface 402 of the molding member 378. The grooves 398 and 400 extend the length of the molding member 378 to engage pegs from other brackets to in effect secure the molding member 378 along its length to the several brackets like bracket 382 positioned along the perimeter like perimeter 36 of the window opening 28 (FIG. 1). The molding member 378 thus is secured to the bracket 382 by a snap fit. The outer edge 406 is formed with a shoulder or finger 407 sized to fit over the base 382. In some cases, caulking 409 or other sealing material may be placed along the outer edge 406 to create a smooth finished appearance with the exterior finishing material 30.

As seen in FIG. 25, the pegs 390 and 394 with the corresponding grooves 398 and 400 are positioned to cause the inner edge 404 of the molding member to be positioned in the wall opening with the outer edge 406 over the interior finish material 30 a distance 408 sufficient for the affixing of the molding member to the bracket 382. At the same time, the notch 380 is thereby positioned relative to the leg 386 of the bracket 382 to form in effect a groove 410 sized to receive the jamb member 388 along with a spring member 412. The inner edge has a ledge 414 is here configured to receive a window shutter and also act as a light block for blinds or a shade 416.

FIG. 26 is a partial cross section view enlarging the peg 418 that extends from the base 419 and the corresponding groove 420 that runs the length (e.g., length 70 in FIG. 9) of the molding member 422. The groove has a width 424 selected to frictionally receive the peg 418. In FIG. 26, the peg 418 is essentially cylindrical in shape with a collar or boss 426 proximate the end 428 of the peg 418. The collar or boss 426 had a diameter 430 that is slightly larger than the width 424 of the groove 420. With the molding member 422 made of wood or a composite, it is susceptible to deformation. In turn, the boss or collar 426 deforms the sides 432 and 434 as the molding 422 is pushed inward 436 toward the base 419 over the peg 418 to effect a frictional engagement of the peg 418 with the collar or boss 424 and the groove 420 and in turn affix the molding member 422 in place against the interior finishing material 30.

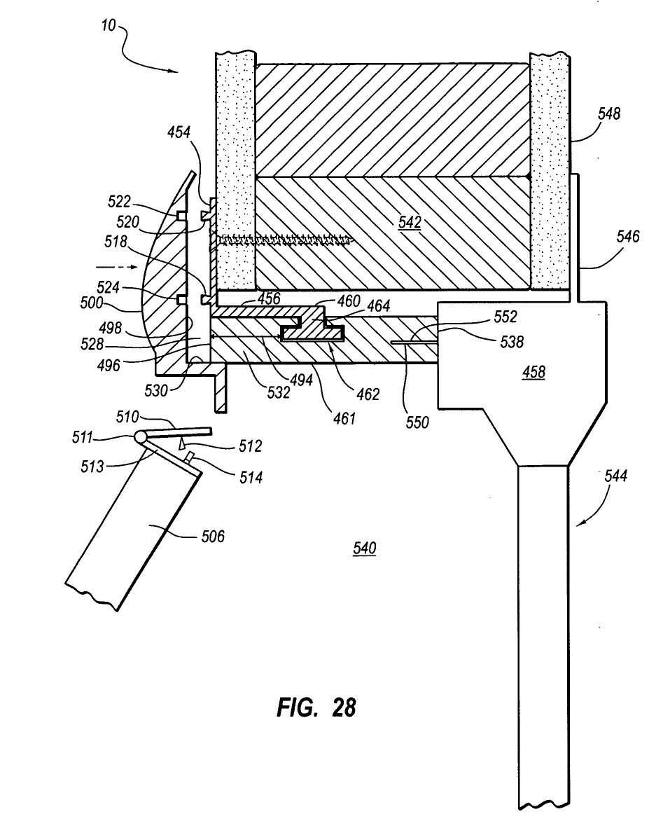

FIG. 27 depicts an alternate configuration of a cylindrical peg 438 extending from base 440 of a bracket like bracket 382. The groove 442 in the molding member 444 has a width 446. The peg 438 has a diameter 448 selected to be inserted into the groove 442 and effect a frictional relationship. That is, the molding member is made of wood, wood substitutes or composites and is deformable. The tip 450 is rounded to facilitate alignment with and the introduction of the peg 438 into the groove 442. Thus the molding 444 can be affixed to the base 440 by urging the molding member 444 inward while effecting a frictional relationship between the groove 442 and the peg 438. It should be understood that the pegs could be in other shapes including square, rectangular, octagonal, or even triangular in projection. Further, the peg-groove securing relationship illustrated in FIGS. 25-27 can be effected using other means and in other forms that could involve taping the outer surface of the peg or forming transverse grooves and a lip or ledge along the groove to effect a snap fit.

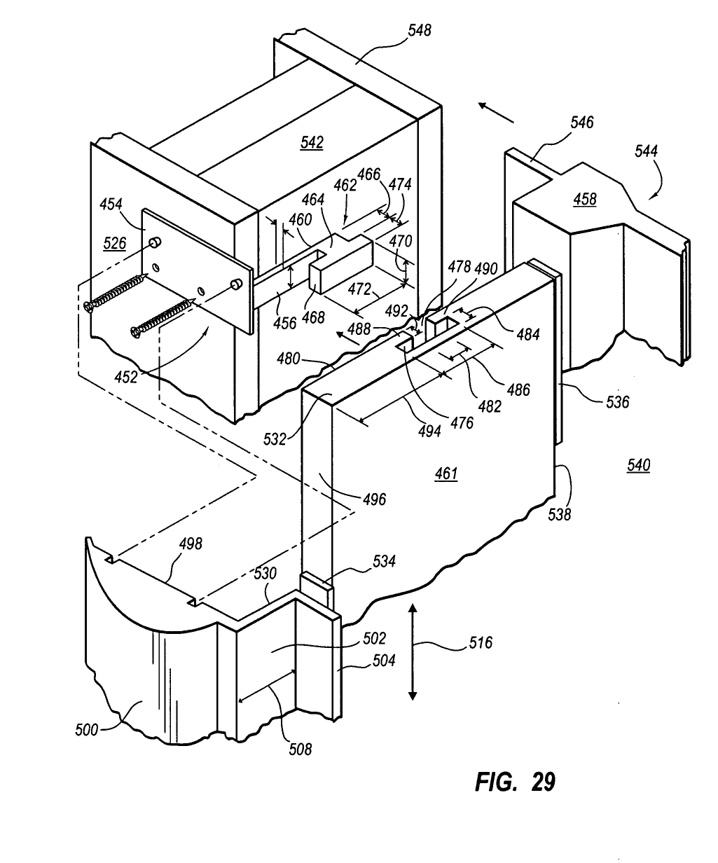

In FIGS. 28 and 29, a bracket 452 has a base 454 with a leg 456 extending essentially normally from the base 454 toward the perimeter member 458. The leg has a height 457 and a width 459 that can be any desired height and width sufficient to provide a stable connection to the jamb member 461 as hereinafter discussed. A “T” shaped engaging member 462 extends outwardly from the distal end 460 of the leg 456. The trunk or stem 464 of the “T” extends away from the distal end 460 a distance 466 to a cross member 468 that has a height 470 a width 472 and a depth 474. The jamb member 461 has “T” shaped slot 476 with a groove 478 formed through the inside surface 480. The groove 478 has a width 482 that is slightly larger than the height 470 of the cross member 468. The slot 476 has a width 486 and depth sized to be slightly larger than the depth 474 and the width 472 of the cross member 468. In turn it can be seen that the bracket 452 may be manipulated to orient the cross member 468 to be in alignment with the groove 478 and to be inserted there through into the slot 476 and then rotated to position the cross member 468 transversely in the slot 476 to engage the sides 488 and 490 of the groove 478. The distance 466 of the stem 464 is comparable to the thickness 492 of the sides 488 and 490. In turn the cross member 468 is snuggly secured in the slot 476 with the inside surface 480 of the jamb member 461 snuggly positioned against the leg 456. The slot 476 and groove 478 are positioned on the inside surface a distance 494 to position the jamb face 496 in alignment with the base 454 and to abut the interior surface 498 of the molding member 500 when assembled.

FIGS. 28 and 29 also show the molding member 500 formed with an extension to define a face 502 with a ledge 504 to receive and support a window shutter 506. The face 502 has a width 508 sized to receive a leaf 510 if hinge 511 secured with one or more screws 512. The other hinge leaf 513 is secured to the shutter 506 with one or more screws 514. Of course a plurality of hinges may be secured to the face 502 along the length 516 of the vertical molding members to securely mount the shutter 506 thereto.

The molding member 500 is also removably secured to a plurality of brackets 452 along the length 516 using pegs 518 and 520 that frictionally mate with grooves 522 and 524. Upon urging the molding member 500 toward 526 and onto the bracket 452, a groove or slot 528 is formed by the leg 456 of the bracket 452 and the inner surface 530 of the extension to snuggly hold or retain the jamb member 461 in position at the molding end 532. A urging means or spring member 534 to urge the jamb 461 toward the perimeter member 458 and to effect a seal between the jamb face 496 and the inside surface 496 of the molding member 500. Another urging means or spring member 536 may be positioned between the outer jamb face 538 and the perimeter member 454 to urge the jamb member toward the molding member 500 and groove 528 and to effect a seal between the jamb face 538 and the perimeter member 454. Both spring members 534 and 536 allow the jamb member 461 to move in and out of the groove 528 to adjust for dimensional variations in the formation of the window opening 540 in the assembly or construction with the frame members like frame member 542. Notably the finishing unit 544 has a flange 546 for attachment to the exterior material 548. If the wall 10 and the external material 548 are out of plum, dimensional variations can be introduced.

In FIG. 28, the perimeter member 458 of the finishing unit 544 has a finger 550 extending there from that engages a slot 552 formed in the jamb face 538 of the jamb member 461. A slot in the spring means 536 may also be provided. The slot 552 and finger 550 allow for slideable movement of the jamb member 461 toward and away from the perimeter member 458 while maintaining the jamb member 461 in general alignment with the perimeter member 458.

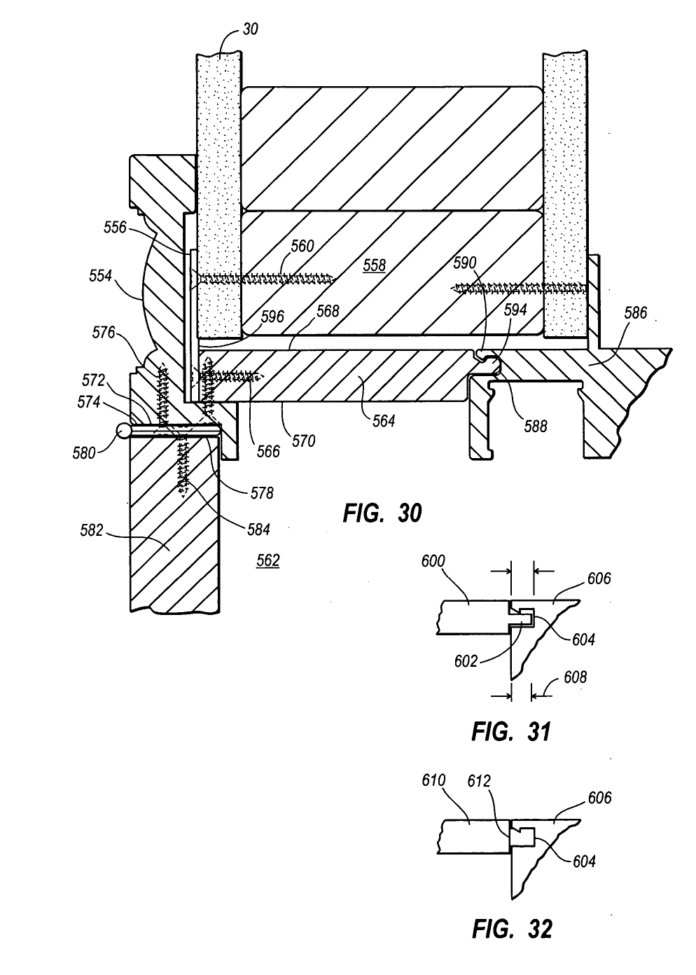

An assembly for finishing a window is seen in partial cross section in FIG. 30. The assembly includes a molding member 554 positioned over bracket 556 which is mounted to the frame member 558 by a screw 560 that extends through the bracket 556, the interior finishing material 30 and into the frame member 558. The bracket 556 extends into the wall opening 562; and the jamb member 564 is connected thereto by a screw 566. The bracket 556 may have a leg (not shown) to extend down and along either the inside surface 568 or outside surface 570.

The molding member 554 has an extension to form a face 572 to which a leaf of hinge 574 is attached by screw 576. The other leaf 578 of the hinge 580 is attached to the window shutter 582 by screw 584.

The jamb member 564 of FIG. 30 extends to the perimeter member 586 which is here shown with an accessory channel 588. The accessory channel 588 includes has a lip portion 590; and the jamb member 564 is formed with a tongue 592 configured in section with a lip portion 594 to conform to the section of the accessory channel 588 and sized to removably fit therein as illustrated. To assemble the assembly of FIG. 30, the jamb member 564 is inserted into the accessory channel 588 typically by rotation of the lip portion 594 into the channel 588 and under the lip portion 590. After installation of a number of brackets 556, the brackets are then secured to the jamb member 564 by screws 566. Depending on dimensional variations, the molding end or face 596 of the jamb member 564 may need to be cut to fit if it is too long. A space or gap may develop between the bracket 556 and the face 596 which can be accommodated or which may require a spacer for stable installation.

FIG. 31 shows a jamb member 600 having a tongue 602 formed that is planar on both sides that simply inserts into the accessory channel 604 of perimeter member 606. The tongue 602 is preferably sized in length 608 to extend into the depth of channel 604. Alternately, jamb member 610 is formed with a flat face 612 to snuggly about the perimeter member 606 as shown in FIG. 32. A spring member (not shown) may be applied or supplied for positioning between the flat face 612 and the perimeter member 606 over the accessory channel 604 to effect a sealing connection between the jamb member 610 and the perimeter member 606.

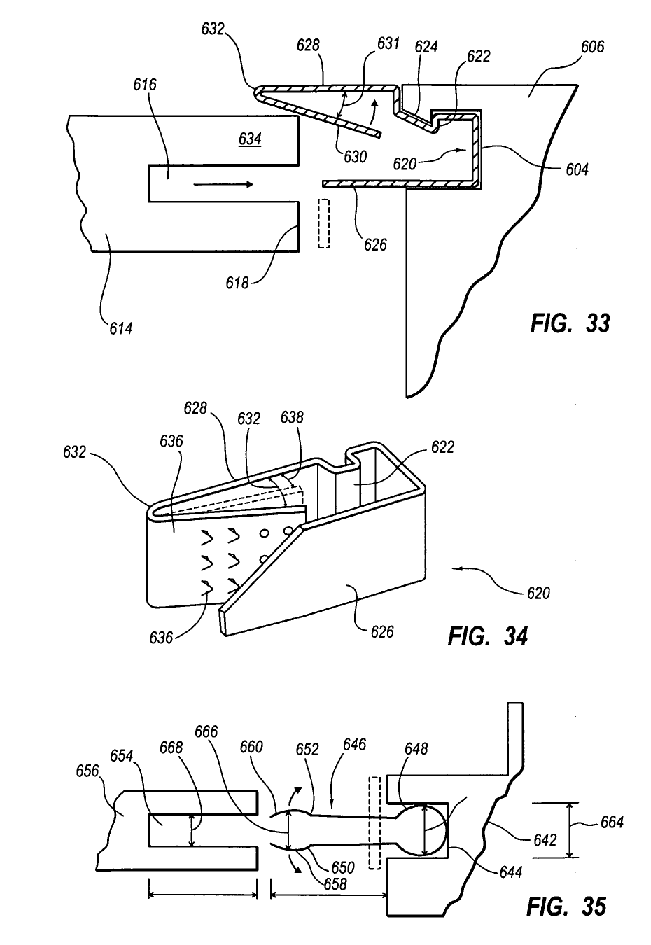

In FIG. 33, a jamb member 614 is formed with a slot 616 in its outer face 618. A clip 620 is formed to fit in the accessory channel 604. The clip 620 is shaped with a lip section 622 to engage the lip section 624 of the accessory channel 604. The clip 620 has a first leg 626 sized to extend into the slot 616. The second leg 628 is spaced from the first leg 626 a distance to engage one leg of the jamb member 614. A spring leaf 630 pivots off the distal end 632 of the second leg 628 and is arranged to extend away from the second leg 628 at an angle 632. As the jamb member 614 is moved toward the perimeter member 606, the leaf 630 is deflected by the leaf 630 toward the first leg 626 to hold the left section 634 of the jamb member there in between.

FIG. 34 shows the clip of FIG. 33 in perspective with the outer surface 636 of the spring leaf 630 having a plurality of teeth 636 much like a rasp. Upon deflection of the leaf member 630 to a second angle 638, the teeth 636 are urged into and engage the left section 634 of the jamb member 614 to retain the jamb member 614 in position snuggly against the perimeter member 606. As seen in FIG. 33, a seal 640 may be placed between the outer face 618 of the jamb member 614 and the perimeter member 606.

In FIG. 35, a perimeter member 642 is formed with an accessory channel 644. A clip 646 is shown that is formed from a suitable plastic or thin metal to have a rounded head 648 sized to fit in the channel 644. The clip 646 has a first leg 650 and a second leg 652 sized in length to extend into the channel 654 formed in jamb member 656. The legs 650 and 652 have arcuate sections 658 and 660 respectively. In an at rest position, the head 648 had a diameter 662 that is larger than the width of the accessory channel 644. Similarly, the distance 666 between the arcuate sections 658 and 660 is larger than the width 668 of the channel 654. The clip 646 is movable from an at rest position by squeezing the legs 650 and 652 together. The movement allows the diameter 662 of the head 648 to reduce and allow the clip 646 to be inserted into the accessory channel 644. At the same time the distance between the legs 650 and 652 is reduced to allow the legs 650 and 652 to be inserted into the channel 654 to effect a stable connection between the perimeter member 642 and the jamb member 656. A sealing member 670 may be inserted between the perimeter member 642 and the jamb member 656 to effect a seal and to urge the jamb member toward the molding member (not shown) as hereinbefore discussed.

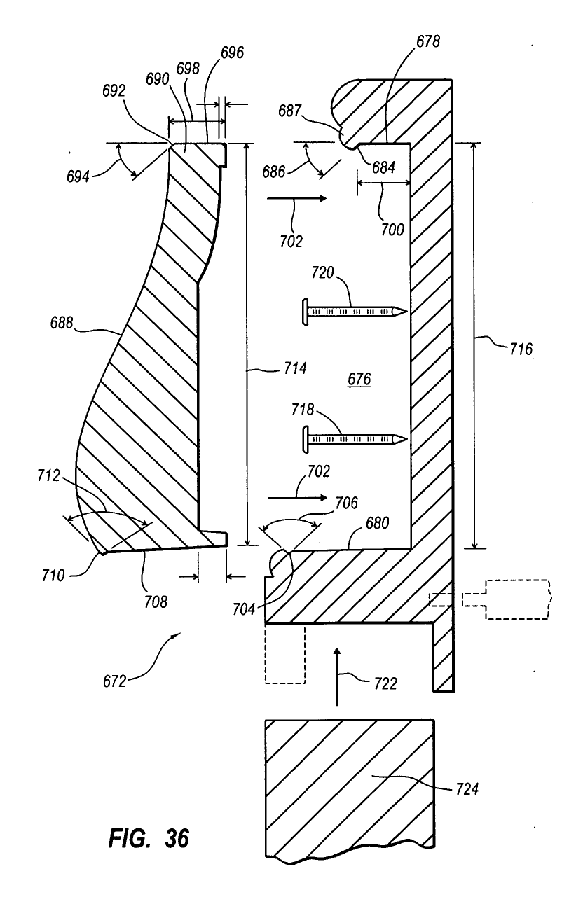

FIG. 36 shows a molding member 672 for use in a finishing assembly. The molding member has a base 674 formed with a recess 676 having a first side 678 and a second side 680. The first side 678 has a lip or ridge 682 formed as shown with an angular surface 684 at an angle 686 from the first side 678. The molding member 672 has an insert 688 for positioning in the recess 676. The insert 688 has a first end 690 with a height 698 about the same as the height 700 of the lip or ridge 682 to position surface 692 having an angle 694 to snuggly interface with surface 684 when the insert 688 is positioned 702 in the recess 676.

The second side 680 of the recess 676 has an indentation 704 formed from two surfaces to define an angle 706. The insert 688 has a second side 708 with a ridge 710 formed of two surfaces with an angle 712 comparable to angle 706. The ridge 710 is positioned to insert into the indentation 704 in the second side 680. That is, the insert 688 has a width 714 almost the same as the width 716 of the recess 676 so that upon insertion 702, the ridge 710 and indentation 704 effectively snap lock the insert 688 into the recess with the surfaces 692 and 684 snuggly in contact and acting as a fulcrum for rotating the second side 708 into position after placing the first side 690 in position.

The molding member 672 of FIG. 36 is held to the framing member by screws 718 and 720. The molding member 672 also has structure 722 to accept window coverings such as a window shutter 724 as shown and as generally discussed hereinbefore.

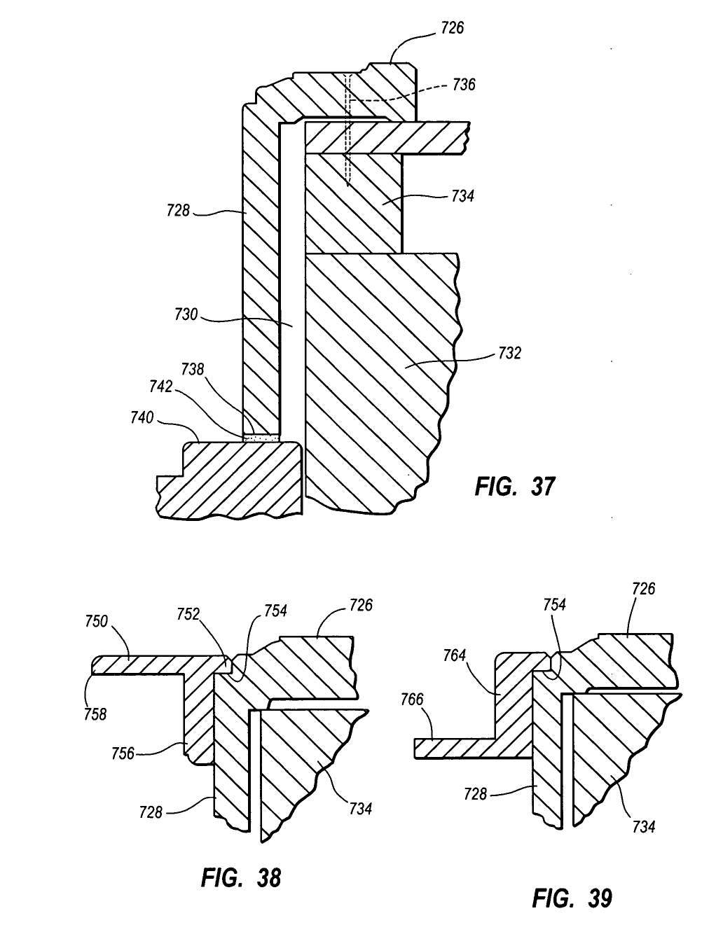

In reference to FIG. 37, a molding member 726 unitarily formed with a jamb member 728 for positioned with a gap 730 between the jamb member 728 and the frame members 732 and 734 to take into account dimensional variations. The molding member 726 may be secured to the frame members using one or more screws, nails 736 or other suitable fasteners. The end 738 of the jamb member is positioned toward the perimeter member 740. A seal or spring member 742 may be positioned between the perimeter member 740 and the spring member 742. In FIG. 38, an adapter 750 is shown with a lip 752 sized to snuggly fit on a ledge 754 of the molding member 726. The adapter 750 is sized to extend the length of the molding members 726 with a flange 756 positioned along the jamb member 728 through which screws, nails, glue or the like may be used to attach the adapter 570 to the jamb member 728 and molding member 726. The adapter 750 of FIG. 38 forms a light block 758 particularly useful for use with window shades and window blinds.

An adapter 760 similar to adapter 750 is shown in FIG. 39. The adapter 760 has a lip 762 formed to interface with the lip 754 and a flange 764 with a ledge 766 extending there from sized to receive window shutters or similar window coverings. The adapter 760 may be secured by use of nails or screws positioned through the flange 764.

The present invention may be embodied in forms besides the specific embodiments presented here without departing from the spirit or essential characteristics of the invention. The described embodiments are to be considered in all respects only as illustrative as those skilled in the art will appreciate alternate and additional embodiments adopting the teachings of the invention and applying the principals and features thereof. For example, those skilled in the art will recognize that fasteners are not to be limited to screws and nails. Other forms of fastening including staples, glues and the like may also be logically suitable in given applications. The scope of the invention is, therefore, set out by and defined by the appended claims rather than by the foregoing description. All changes that come within the meaning and range of equivalency of the claims are to be embraced within their scope.

What is claimed:

1. An assembly for finishing a wall opening, said wall opening being configured to receive a finishing unit, said wall opening being formed from frame means for defining said wall opening, said wall opening being formed in a wall having an interior wall material and an exterior wall material, said finishing unit having perimeter means for receiving window material and for orientation toward said frame means, said assembly comprising:
molding means for finishing said wall opening, said molding means being formed and sized for positioning over said interior wall material and with an interior edge and an exterior edge, said molding means having said interior edge positioned in said wall opening and said molding means having a width selected to position said exterior edge over said interior wall material a distance sufficient for securing means to secure said molding means there over;
jamb means for providing an interior finish surface, said jamb means being configured for positioning between said perimeter means and said molding means, said jamb means being sized in length to extend along the length of said interior edge of said molding means; and
urging means for urging said jamb means toward one of said molding means and said perimeter means, said urging means being configured for positioning between one of said molding means and said jamb means and between said perimeter means and said jamb means.

2. An assembly for finishing a wall opening, said wall opening being configured to receive a finishing unit, said wall opening being formed from at least one framing member having a frame member length, said at least one framing member defining said wall opening, said wall opening being formed in a wall having an interior wall material and an exterior wall material, said finishing unit having at least one perimeter member oriented toward said at least one framing member, said assembly comprising:
molding means for finishing said wall opening, said molding means being formed and sized for positioning over said interior wall material and with an interior edge and an exterior edge, said molding means having said interior edge positioned in said wall opening and said molding means having a width selected to position said exterior edge over said interior wall material a distance sufficient for securing means to secure said molding means there over;
jamb means for providing an interior finish surface, said jamb means being configured for positioning between said at least one perimeter member and said molding means, said jamb means being sized in length to extend along the length of said interior edge of said molding means; and
urging means for urging said jamb means toward one of said molding means and said at least one perimeter member, said urging means being configured for positioning between one of said molding means and said jamb means and between at least one perimeter member and said jamb means.

3. The assembly of claim 2 wherein said jamb means and said molding means are unitarily formed together with said urging means being positioned between said jamb means and said perimeter member.

4. The assembly of claim 2 wherein said finishing unit is a window unit.

5. The assembly of claim 2 wherein said urging means includes a first seal member to urge said jamb means toward one of said molding means and said perimeter means and to effect a seal there between.

6. The assembly of claim 5 wherein said first seal member is positioned between said jamb means and said molding means and wherein said urging means includes a second seal member positioned between said jamb means and said perimeter means to effect a seal between the jamb means and said perimeter means.

7. The assembly of claim 2 wherein said wall opening is circular in shape.

8. The assembly of claim 2 wherein said wall opening is ovular in shape.

9. The assembly of claim 2 wherein said wall opening is polygonal in shape.

10. An assembly for finishing a wall opening, said wall opening being configured to receive a finishing unit, said wall opening being formed from a plurality of framing members each having a frame member length, said plurality of framing members being assembled to define said wall opening, said wall opening being formed in a wall having an interior wall material and an exterior wall material, said finishing unit having a plurality of perimeter members each oriented respectively toward one of said plurality of framing members, said assembly comprising:
a plurality of molding members each for positioning over said interior wall material, each of said plurality of molding members having an interior edge and an exterior edge, each of said plurality of molding members having its said interior edge positioned in said wall opening, each of said plurality of molding members having a width selected to position said exterior edge over said interior wall material a distance selected for attaching said molding members there over;
a plurality of jambs each sized in width to extend between one of said plurality of perimeter members and one of said plurality of molding members, each of said jambs being sized in length to extend the length of the interior edge of one of said molding members; and
spring means for urging one of said plurality of jambs toward one of said molding members and one of said perimeter members, said spring means being configured for positioning between one of said plurality of molding members and one of said plurality of perimeter members.

11. The assembly of claim 12 wherein said finishing unit is a window unit.

12. The assembly of claim 11 wherein said plurality of framing members is four framing members assembled to define a window opening rectangular in projection.

13. The assembly of claim 12 wherein said spring means includes a resilient member that extends the length of each of said jambs.

14. The assembly of claim 13 wherein said spring means includes molding resilient members each of which extends the length of each of said jambs and each of which is positioned between a said jamb and a said molding member.

15. The assembly of claim 14 wherein said spring means includes perimeter resilient members each of which extends the length of each of said perimeter members and each of which is positioned between a jamb and a corresponding resilient member.

16. The assembly of claim 15 wherein said molding resilient members are configured to effect a seal between said molding members and said jambs.

17. The assembly of claim 16 wherein said perimeter resilient members are configured to effect a seal between said jambs and said perimeter members.

18. The assembly of claim 10 further including jamb fastening means for securing two said adjacent jambs to each other.

19. The assembly of claim 18 wherein said jamb fastening means includes a rigid clip having a base with a first section for positioning proximate one of said two adjacent jambs and a second section for positioning proximate the other of said two adjacent jambs and first securing means for securing said first section to said one of two adjacent jambs and a second securing means for securing said second section to said other of said two adjacent jambs.

20. The assembly of claim 19 wherein said base, said first section and said second section are unitarily formed with said first section and said second section, said first section and said second section each being bent relative to said base.

21. The assembly of claim 18 wherein each of said jambs of said two adjacent jambs have ends for positioning proximate each other, wherein said jamb fastening means includes a first groove transversely formed in one of two adjacent jambs, a second groove transversely formed in the other of said two adjacent jambs and a clip having a first leg and a second leg joined together, each of said first leg and said second leg having one of two spaced apart fingers, each finger being sized to engage one of said grooves with said first leg and second leg being sized in length to urge said first jamb toward said second jamb with two spaced apart fingers engaged in first groove and said second groove.

22. The assembly of claim 10 wherein said molding means includes at least one molding member with its interior edge positioned within said window opening, and wherein said molding member includes window covering support structure extending away there from and configured to receive and support a window covering.

23. The assembly of claim 22 wherein said window covering support structure includes an “L” support to receive and support a window covering, said “L” support having a first leg extending from said interior edge transversely toward said window to a first leg distal end and a second leg extending transversely from said first leg distal end into said window opening.

24. The assembly of claim 22 wherein said window covering support structure includes a base for attachment to the interior edge of said molding member and a light shield member extending there from.

25. The assembly of claim 10 wherein each molding member has two opposite ends, an inner surface and an outer surface, and wherein a groove is formed in said inner surface to extend between said two opposite ends, and wherein said jambs are formed with a tongue sized to engage said groove.

26. The assembly of claim 25 wherein said spring means is positioned in said groove.

27. The assembly of claim 10 further including a plurality of brackets for securing to said interior wall material proximate said window opening, each of said plurality of brackets having a base with a distal end extending into said window opening and a leg extending from said distal end toward said window unit, and wherein said assembly further includes first fastening means for securing a said molding member to selected brackets of said plurality of brackets and second fastening means for securing a said jambs to selected legs of said plurality of brackets.

28. The assembly of claim 27 wherein said plurality of brackets are spaced apart about said window opening.

29. The assembly of claim 27 wherein said base of each said bracket has a proximal end with a first tip extending away there from and a second tip extending away from said distal end, and wherein each said molding member has an interior surface with a recess formed therein, said recess having a first side extending into said molding member, said first side having a first ridge formed there along positioned and sized to engage a said first tip, and wherein said recess has a second side extending into said molding member, said second side having a second ridge formed there along sized and positioned to engage said second tip.

30. The assembly of claim 10 wherein said jamb members have an outer face oriented outwardly from said window opening and wherein said outer face has a jamb groove formed therein, and wherein said molding member has a tongue sized and positioned to engage said jamb groove.

31. The assembly of claim 27 wherein each of said plurality of brackets has a first engaging member extending away from said base spaced inward from said distal end, and wherein said interior surface of each of said molding members has a first groove formed therein sized to engage with said first engaging member to hold said molding member to said bracket.

32. The assembly of claim 31 wherein each of said plurality of brackets has a second engaging member extending away there from, and wherein said interior surface of said molding member has a second groove formed there in sized to engage said second engaging member to hold said molding member to said bracket.

33. The assembly of claim 28 wherein said second fastening means includes an engaging member extending from said first leg and a slot formed in each jamb sized to receive said engaging member and hold said jamb to said engaging member.

34. The assembly of claim 33 wherein said engaging member is “T” shaped in cross section with a stem and a cross member having a width, a height and a depth, and wherein said slot includes a throat sized in width to receive said stem and to receive the width of said cross member, and wherein said slot includes a cross member recess formed in said jambs to receive said cross member.

35. The assembly of claim 10 wherein each of said perimeter members has an accessory recess formed therein oriented inwardly toward said jambs, and wherein each of said jambs has an accessory tongue formed for positioning in said accessory recess.

36. The assembly of claim 35 wherein said accessory recess has an engaging shoulder, and wherein said accessory tongue is formed with a lip sized to engage said engaging shoulder.

37. The assembly of claim 10 wherein each of said perimeter members has an accessory recess formed therein oriented inwardly toward said jambs, and wherein said assembly further includes a plurality of clips each sized for positioning in a said accessory recess and configured to engage said jambs.

38. The assembly of claim 37 wherein each of said jambs has a perimeter face for orientation toward said perimeter members, and wherein each of said jambs has a slot formed therein.

39. The assembly of claim 38 wherein each of said plurality of clips is formed to have a first outwardly extending leg and a second outwardly extending leg, said second outwardly extending leg having a distal end with a spring member extending there from, and wherein said jamb members have an inner surface with said slot being sized to receive said first outwardly extending leg, said second outwardly extending leg being configured to extend along proximate the said inner surface of said jamb with said spring member being urged against said interior surface.

40. The assembly of claim 38 wherein each of said plurality of clips is formed with a first engaging section sized to be movable between a first position in which it engages said accessory recess and a second position in which the first engaging section is reduced in size to disengage from said accessory recess, wherein each of said plurality of clips has a first leg and a second leg spaced apart from said first leg to extend from said engaging section and wherein said first leg and said second leg have a second engaging section movable between a first position in which engages said slot of said jambs and a second position in which is disengaged from said slot.

41. The assembly of claim 10 wherein each of said perimeter members has an accessory slot formed therein and wherein said jambs have a tongue formed to engage said accessory slot.

42. The assembly of claim 3 wherein said molding means and said jamb means are assembled to define and form an exterior ledge along their lengths, and wherein said assembly further includes a window covering adapter having a lip sized to engage said ledge and a base for attachment to and to abut said jamb, said window covering adapter having an extension to extend away from said base.

43. The assembly of claim 42 wherein said base has an interior end and wherein said extension is formed at said interior end to extend away from said base, said extension and said base being sized to receive a window shutter.

44. The assembly of claim 41 wherein said base has an exterior end and wherein said extension extends away from said exterior end to be a light block for a window covering.

45. An assembly for finishing a window unit installed a in window opening, said window opening being formed from at least a first framing member having a first length, a second framing member having a second length and a third framing member having a third length, said first framing member, said second framing member and said third framing member being assembled for defining said window opening, said window opening being positioned in a wall having an interior wall material and an exterior wall material, said window unit having a first perimeter, a second perimeter and a third perimeter each oriented respectively toward said first framing member, said second framing member and said third framing member, each of said first perimeter, said second perimeter and said third perimeter having an outer edge and an inner edge, said assembly comprising:
a first molding member for positioning over said interior wall material, said first molding member having a first interior edge, a first exterior edge, said first molding member being formed to have said first interior edge positioned toward the interior of said window opening, said first interior edge being sized have a length less than the first length of said first framing member, said first molding member having a width selected for positioning said first exterior edge sufficiently over said interior wall material and over said first framing member for attaching said first molding member to one of said wall material and said first framing member;
a second molding member for positioning over said interior wall material, said second molding member having a second interior edge and a second exterior edge, said second molding member being formed to have said second interior edge positioned toward the interior of said window opening, said second interior edge being sized have a length less than the second length of said second framing member, said second molding member having a width selected for positioning said second exterior edge sufficiently over said interior wall material and over said second framing member for attaching said second molding member to one of said wall material and said second framing member;
a third molding member for positioning over said interior wall material, said third molding member having a third interior edge and a third exterior edge, said third molding member being formed to have said third interior edge positioned toward the interior of said window opening, said third interior edge being sized have a length less than the third length of said third framing member, said third molding member having a width selected for positioning said third exterior edge sufficiently over said interior wall material and over said third framing member for attaching said third molding member to one of said wall material and said third framing member;
a first jamb for positioning between said first perimeter and said first molding member and sized in length to extend at least the length of said first interior edge of said first molding member;
a second jamb for positioning between said second perimeter and said second molding member and sized in length to extend at least the length of said second interior edge of said second molding member;
a third jamb for positioning between said third perimeter and said third molding member and sized in length to extend at least the length of said third interior edge of said third molding member;
first adjusting means for positioning between one of said first molding member and said first perimeter, said first adjusting means being configured to urge said first jamb toward one of said first molding member and said first perimeter along the length of said first jamb;
second adjusting means for positioning between one of said second molding member and said second perimeter, said second adjusting means being configured to urge said second jamb toward one of said second molding member and said second perimeter along the length of said second jamb; and
third adjusting means for positioning between one of said third molding member and said third perimeter, said third adjusting means being configured to urge said third jamb toward one of said third molding member and said third perimeter along the length of said third jamb.

46. The assembly of claim 45
wherein said window opening is rectangular in shape and is formed from at least said first framing member, said second framing member, said third framing member and a fourth framing member having a fourth length,
wherein said window unit includes a fourth perimeter oriented toward said fourth framing member, said fourth perimeter having an outer edge and an inner edge,
wherein said assembly further includes a fourth molding member for positioning over said interior wall material, said forth molding member being arranged with said first molding member, said second molding member and said third molding member to form a rectangular casing for positioning about said window opening, said fourth molding having a fourth interior edge, a fourth exterior edge, a first end and a second end, said fourth molding member being formed to have said fourth interior edge positioned toward said interior of said window opening, said fourth interior edge being sized to have a length less than the fourth length of said fourth framing member, said fourth molding member having a width selected for positioning said fourth exterior edge sufficiently over said interior wall material and over said fourth framing member for attaching said fourth molding member to one of said wall material and said fourth framing member.

47. The assembly of claim 46 further including a fourth jamb for positioning between said fourth perimeter and said fourth molding member, said fourth jamb being sized in length to extend at least the length of said fourth interior edge of said fourth molding member; and further including fourth adjusting means for positioning between one of said fourth molding member and said fourth perimeter, said fourth adjusting means being configured to urge said fourth jamb toward one of said fourth molding member and said perimeter.

48. The assembly of claim 45 wherein said first adjusting means includes a first molding resilient member positioned between said first molding member and said first jamb to urge said first jamb toward said first perimeter.

49. The assembly of claim 45 wherein said first adjusting means includes a first window unit resilient member positioned between said first jamb and said first perimeter.

50. The assembly of claim 45 wherein said first molding member has a first grove formed therein along the first length, wherein said first jamb has a first tongue formed along one edge extending between its opposite ends sized to extend into said first grove, and wherein said first adjusting means includes a first groove resilient member positioned in said first grove to abut said first tongue to urge said first jamb toward said first perimeter.

51. The assembly of claim 45 wherein said first perimeter has a first length and wherein said
first perimeter has a first recess formed therein along said first length, and wherein said first jamb is formed with a first extension sized to fit into said first recess.

52. The assembly of claim 51 wherein said first adjusting means includes a first unit resilient member positioned between said first jamb and said first perimeter.

53. The assembly of claim 45 wherein said molding members are formed to present a decorative external appearance.

54. The assembly of claim 45 wherein said assembly is configured and sized to contain a window covering.

55. The assembly of claim 54 wherein said window covering is one of the group consisting of a window shutter structure, a window blind system and a window shade.

56. A framing system for framing an opening, said framing system comprising:
a wall in which a wall opening is formed, said wall having an inner surface and said wall opening having a perimeter;
an installation unit mounted within said wall opening;
a preassembled decorative frame unit having:
molding members assembled into a frame to extend about and proximate the perimeter of said wall opening, said molding members being configured to be secured against said inner surface of said wall, and
a jamb frame having an inner edge and an outer edge, said jamb frame being sized to extend from said installation unit to said molding members, said jamb frame being secured by and between said molding members and said installation unit.

57. The framing system of claim 56 further including spring means positioned between one of said molding members and said jamb frame to urge said jamb frame against said installation unit.

58. The framing system of claim 56 further including spring means positioned between one of said jamb frame and said installation unit to urge said jamb frame against said installation unit.

59. The framing system of claim 56 wherein said wall opening is a window opening.

60. The framing system of claim 56 wherein said molding members have a groove formed therein sized to receive a tongue formed in the jamb frame and positioned for insertion into said groove.

61. The system of claim 56 wherein said molding member has an “L” shaped recess mechanically associated therewith sized to receive and retain a window covering.

62. A method for framing an opening in the wall of a building, said method comprising:
providing a wall with an opening formed therein sized to receive a decorative unit;
providing a decorative unit sized to fit in the said opening;
positioning said decorative unit in said opening and securing said decorative unit to said wall;
forming a decorative frame unit by assembling
molding members into a frame to extend about and proximate the perimeter of said wall opening, said molding members being configured to be secured against said inner surface of said wall, and
a jamb frame formed of jambs having an inner edge and an outer edge, said jamb frame being sized to extend from said installation unit to said molding members, said jamb frame being secured by and between said molding members and said installation unit;
positioning said decorative frame unit in said wall opening;
squaring said decorative frame unit in said wall opening; and
securing said decorative frame unit in said wall opening.

63. The method of claim 62 further including providing and installing spring means between each one of said molding members and said jamb frame to urge said jamb frame against said installation unit.

64. The method of claim 63 wherein said wall opening is a door opening.

65. The method of claim 63 wherein said wall opening is a window opening.

66. The method of claim 65 further including forming said molding members to have a recess to extend about said perimeter and sized to receive a window covering.

67. The method of claim 66 wherein said window covering is one of a window blind, a window shutter and a window shade.

68. A method for framing an opening in the wall of a building, said method comprising:
providing a wall with an opening having a perimeter and formed from frame members, said opening having first dimensions;
providing a finishing unit having second dimensions selected to be less than and proximate said first dimensions for fitting said finishing unit in said opening;
positioning said finishing unit in said opening and securing said finishing unit to one of said wall and said frame members;
forming a decorative frame unit by assembling
a molding frame comprised of molding members sized to extend over proximate the perimeter of said wall opening, said molding members being configured to be secured against said wall and to finish the said perimeter, and
a jamb frame having third dimensions selected to be less than said first dimensions and formed of jambs having an inner edge and an outer edge, said jamb frame being sized to extend between said finishing unit to said molding frame, said jamb frame being secured by and between said molding frame and said finishing unit;
positioning said decorative frame unit in said wall opening;
squaring said decorative frame unit in said wall opening; and
securing said decorative frame unit in said wall opening.

69. The method of claim 68 further including
providing spring means for positioning between said molding frame and said jamb frame to urge said jamb frame toward said finishing unit.
